(19) United States
(12) Patent Application Publication
(10) Pub. No.: US 2023/0178891 A1
(43) Pub. Date: Jun. 8, 2023

(54) Dual Reception Antennas for Precise Alignment of Users in 5G/6G

(71) Applicants: David E. Newman, Poway, CA (US); R. Kemp Massengill, Palos Verdes, CA (US)

(72) Inventors: David E. Newman, Poway, CA (US); R. Kemp Massengill, Palos Verdes, CA (US)

(21) Appl. No.: 17/943,743

(22) Filed: Sep. 13, 2022

Related U.S. Application Data
(60) Provisional application No. 63/401,811, filed on Aug. 29, 2022.

(51) Int. Cl. H01Q 3/36; H01Q 3/26

(52) U.S. Cl. CPC H01Q 3/36; H01Q 3/267

(57) ABSTRACT

Methods are disclosed for a base station to align its transmission and reception beams toward a user device by analyzing signals from two spaced-apart antennas in 5G or 6G. At least one of the antennas is a phased-array antenna, configured to determine the angle of arrival of the transmission with resolution limited by the size of the antenna. At the same time, the base station can measure a phase shift or timing difference between the two antennas, and thereby determine a series of candidate angles, one of which is consistent with the single-antenna distribution. The base station thereby determines the alignment direction toward the user device. The method is quick, uses just a brief single pulse from the user device, and provides a specific alignment direction for transmission and reception beams at the user device and the base station. Many options and other aspects are disclosed.

### PRIORITY CLAIMS AND RELATED APPLICATIONS

This application claims the benefit of U.S. Provisional Patent Application Ser. No. 63/401,811, entitled “Dual Reception Antennas for Precise Alignment of Users in 5G/6G”, filed Aug. 29, 2022, all of which are hereby incorporated by reference in their entireties.

### FIELD OF THE INVENTION

The disclosure pertains to wireless beamforming, and more particularly to means for selecting an optimum beam direction.

### BACKGROUND OF THE INVENTION

In 5G and 6G, many communications are carried out using “beams” or directed radiation, aimed at the intended recipient. However, a complex time-consuming procedure is required to align the beams in the right directions. What is needed is a simpler, more efficient procedure for determining an optimal beam direction for each recipient.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY OF THE INVENTION

In a first aspect, there is a system comprising a first phased-array antenna, the first phased-array antenna comprising a plurality of reception elements, the system configured to: detect a pulse of electromagnetic energy, arriving at an angle of arrival relative to the first phased-array antenna; determine a first phase or time related to the pulse in a first reception element; determine a second phase or time related to the pulse in a second reception element, the second reception element separated from the first reception element by a width of the first phased-array antenna; determine a first phase shift or timing difference comprising the first phase or time minus the second phase or time; and determine, according to the first phase shift or timing difference, and according to the width of the first phased-array antenna, and according to a frequency of the pulse, a first angular probability distribution of the angle of arrival.

In another aspect, there is a method for a user device to determine an alignment angle toward a base station, the method comprising: receiving, from the base station, an indication of an assigned subcarrier and an assigned symbol-time; at the assigned symbol-time, transmitting an alignment pulse comprising electromagnetic energy at a frequency corresponding to the assigned subcarrier; then receiving, from the base station, a message indicating a suggested alignment direction; then receiving a plurality of test pulses, wherein: each test pulse is transmitted, by the base station, with the same amplitude, direction, modulation, and frequency; each test pulse is received, by the user device, using a different reception beam direction; then determining a user device alignment angle toward the base station according to which reception beam direction provided a best reception of one of the test pulses.

In another aspect, there is non-transitory computer-readable media in a base station of a wireless network, the media containing instructions that, when implemented in a computing environment, cause a method to be performed, the method comprising: configuring two antennas, at least one being a phased-array antenna, to receive signals according to the same clock or time-base; receiving, in the two antennas, a pulse transmitted by a user device; determining a phase shift or timing difference between pulse signals received in two spaced-apart reception elements of the phased-array antenna; determining, according to the phase shift or timing difference, and according to a separation between the two spaced-apart reception elements, an angular probability distribution of an angle of arrival of the pulse; determining a second phase shift or timing difference between pulse signals received in the two antennas; determining, according to the second phase shift or timing difference, and according to a separation between the antennas, a plurality of candidate angles; selecting which candidate angle most closely matches the angular probability distribution; and determining, according to the selected candidate angle, the angle of arrival.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

These and other embodiments are described in further detail with reference to the figures and accompanying detailed description as provided below.

### BRIEF DESCRIPTION OF THE DRAWINGS

FIG. 1A is a schematic showing an exemplary embodiment of dual antennas, according to some embodiments.

FIG. 1B is a chart showing an exemplary embodiment of an angle of arrival as measured by the antennas of FIG. 1A, according to some embodiments.

FIG. 2 is a flowchart showing an exemplary embodiment of a procedure for a base station to determine a user device alignment direction during initial access, according to some embodiments.

FIG. 3A is a schematic showing an exemplary embodiment of dual antennas with asymmetric antennas, according to some embodiments.

FIG. 3B is a chart showing an exemplary embodiment of an angle of arrival as measured by the antennas of FIG. 3A, according to some embodiments.

FIG. 4 is a flowchart showing an exemplary embodiment of a procedure for a user device to request re-alignment after losing beam contact with a base station, according to some embodiments.

FIG. 5A is a schematic showing an exemplary embodiment of three spaced-apart antennas, according to some embodiments.

FIG. 5B is a chart showing an exemplary embodiment of an angle of arrival as measured by the antennas of FIG. 5A, according to some embodiments.

FIG. 6A is a schematic showing an exemplary embodiment of multiple spaced-apart antennas, according to some embodiments.

FIG. 6B is a chart showing an exemplary embodiment of an angle of arrival as measured by the antennas of FIG. 6A, according to some embodiments.

FIG. 7 is a flowchart showing an exemplary embodiment of a procedure for a base station to process signals from multiple antennas, according to some embodiments.

FIG. 8A is a schematic showing an exemplary embodiment of antennas for angle determination using multiple frequencies, according to some embodiments.

FIG. 8B is a chart showing an exemplary embodiment of an angle of arrival as measured using multiple frequencies, according to some embodiments.

FIG. 9 is a flowchart showing an exemplary embodiment of a procedure for a base station to determine an angle using multiple frequencies, according to some embodiments.

FIG. 10 is a schematic showing an exemplary embodiment of a wireless network with dual antenna beam alignment, according to some embodiments.

FIG. 11 is a flowchart showing an exemplary embodiment of a procedure for a base station to determine an alignment angle for each user device, according to some embodiments.

FIG. 12 is a chart showing an exemplary embodiment of a resource grid with multiple user device alignment pulses, according to some embodiments.

FIG. 13 is a chart showing an exemplary embodiment of waveforms in two spaced-apart antennas, according to some embodiments.

FIG. 14A is a chart showing an exemplary embodiment of waveforms in a quadrature-modulated alignment pulse, according to some embodiments.

FIG. 14B is a polar plot showing an exemplary embodiment of a received quadrature-modulated alignment pulse in two spaced-apart antennas, according to some embodiments.

FIG. 15 is a flowchart showing an exemplary embodiment of a procedure for determining an alignment direction according to quadrature-modulated pulses, according to some embodiments.

Like reference numerals refer to like elements throughout.

### DETAILED DESCRIPTION

Systems and methods disclosed herein (the “systems” and “methods”, also occasionally termed “embodiments” or “arrangements” or “versions” or “examples”, generally according to present principles) can provide urgently needed wireless communication protocols for aligning transmission beams and directional receiver antennas to improve communication quality. Instead of wasting time and resources on prior-art multi-step beam scanning procedures, the procedures disclosed herein can enable a base station to select the best beam direction toward a user device using “dual-antenna reception” to precisely determine the angle of arrival of a message from the user device. Dual-antenna reception, as used herein, refers to coherent reception of a transmission in two (or more) reception antennas, spaced apart and configured to measure a phase shift or time difference between the two received antenna signals, from which the alignment angle to the user device can be determined.

Base stations in 5G and 6G commonly have more than one antenna in service. In one embodiment, a base station can receive a brief transmission pulse from a user device in a single phased-array antenna, and can determine a “single-antenna” angular probability distribution of the angle of arrival, based on a phase shift or timing difference in reception elements across the antenna. At the same time, the base station can receive the transmission in two spaced-apart antennas using a common clock or time-base, and thereby determining another phase shift or timing difference between the two antenna signals. Based on the separation between the two antennas, and the measured phase shift or timing difference between them, the base station can determine a plurality of “candidate” angles, only one of which is consistent with the single-antenna distribution. The base station can thereby select the correct candidate angle, and can then calculate the alignment direction toward the user device with the improved resolution of the dual-antenna data. The method is rapid and uses a minimum of resources.

The alignment procedure may be triggered by any number of events that require alignment of a beam. For example, a new user device can transmit an entry-request message to the base station requesting registration in the base station's cell. In one embodiment, the entry-request message may be a random access preamble message, which is transmitted on the base station's random access channel. In another embodiment, the entry-request message may be a brief transmission such as a code, transmitted on a predetermined contention-based channel, which is allocated for such entry requests. In either case, the base station may receive the entry-request message in two spaced-apart antennas, one of which is a phased-array antenna, and can determine the angle of arrival using the single-antenna procedure and the dual-antenna procedure, and then select the angle of arrival for consistency between the two distributions.

First, the base station may determine a single-antenna angular probability distribution using the phased-array antenna alone, by measuring a phase or time of the reception at one edge of the antenna, and likewise at the opposite edge of the antenna. The difference between those measurements is a measure of the time required for the transmitted pulse to traverse the width of the antenna, as viewed by the incoming wave, and hence is related to the angle of arrival. Second, the base station can determine another phase shift or timing difference between the two antennas, and determine the plurality of candidate angles accordingly. The base station can then select which of the candidate angles is consistent with the single-antenna distribution, and hence represents the angle of arrival. The base station can then calculate the alignment angle toward the user device by adjusting the angle of arrival according to a geographical direction, such as north.

In determining the phase shift or timing difference between the pulse receptions at the two antennas, the base station can use the same clock or time-base for processing the two reception signals (instead of adjusting each antenna's time-base according to a received signal as is commonly done).

The phase shift or timing difference between two spaced-apart antenna receptions generally depends on the angle of arrival, but also depends on an unknown number of full wavelengths of the pulse between the two antenna positions. Hence, the plurality of candidate angles is due to the unknown number of wavelengths in the space between the two antennas. In the disclosed procedure, the base station can break that ambiguity by selecting which of the candidate angles is closest to the single-antenna distribution The single-antenna does not have such an ambiguity because the phased-array antenna generally includes a multitude of independent reception elements which, when combined in analysis, determine a single angular probability distribution of the angle of arrival. By selecting the candidate angle that most closely matches that single-antenna distribution, the base station can determine the angle of arrival (and hence the alignment angle toward the user device) unambiguously, with relatively high resolution, at minimal expense of power and bandwidth.

As an option, the alignment procedure may be triggered by a user device that was previously in beam communication with the base station, but now has lost beam contact (due to motion or rotation of the user device, a changing electromagnetic environment, or other effect). To initiate the alignment service, the user device may transmit a re-alignment request message to the base station using a non-directional antenna, or with a broad transmission beam encompassing the previous alignment direction. The re-alignment request message may be a random access preamble, and therefore triggers the initial access process again, or it may be a brief code transmitted on a contention-based channel allocated for such requests. The alignment request message may be a standardized message or a predetermined code on a contention-based channel, or it may be a signal such as a brief pulse on a predetermined frequency and time allocated for indicating that re-alignment is requested. As a further option, the base station may schedule periodic alignment sessions semi-statically, and a user device that needs realignment service can participate by transmitting an alignment pulse at its assigned time and frequency. The base station can then receive those pulses in two spaced-apart antennas, calculate the angle of arrival for each pulse, and thereby determine the alignment angle for each participating user device, as described above.

In one embodiment, the base station may use the alignment request message itself as the incoming pulse for determining the updated alignment direction. To do so, the base station may arrange to receive signals from the two spaced-apart antennas coherently, during each random access interval (or during other intervals allocated for alignment requests). As mentioned, coherent reception refers to processing the reception signals from the two antennas using the same clock or time-base, configured to reveal differences in phase or timing between the two antenna receptions.

In some embodiments, the base station may transmit a series of identical test pulses, all with the same amplitude, frequency, modulation, and direction, after transmitting the alignment message. The test pulses may assist a user device in aligning its reception beam direction. The test pulses may be transmitted in the alignment message, concatenated with the alignment message, or at a later time following the alignment message. The test pulses can be transmitted as a time-spanning message, that is, occupying successive symbol-times in the same subcarrier. The user device can then receive the test pulses while applying various reception beams at various beam directions, and can measure a signal quality of each test pulse, and can determine which reception beam direction provides the best signal quality. In this way, the user device can determine its alignment direction, different from the base station's suggested alignment direction, with minimal additional resource usage. For example, the user device can receive the test pulses while varying the reception beam direction by ±3 degrees, ±6 degrees, and so forth, relative to the base station's suggested alignment angle, and can then select its own best alignment direction for signal quality.

In some embodiments, the base station can receive the alignment pulse in two antennas that have identical properties, such as two phased-array antennas of the same size. In other embodiments, the two antennas may be quite different, such as one phased-array antenna and the other a non-directional antenna, for example. The base station can then determine an angular probability distribution from the phased-array antenna alone, and can simultaneously determine a plurality of candidate angles according to signal differences in the spaced-apart antennas. By selecting the candidate angle that best matches the single-antenna angular probability distribution, the base station can determine the angle of arrival, and therefore the alignment angle toward the user device, with the precision of the dual-antenna measurement.

Reciprocity is assumed throughout, in the sense that, for each wireless entity, the best alignment angle for transmission is assumed optimal for reception as well. Directions, and the angles representing them, are used interchangeably herein. The 180-degree difference between the base station's alignment direction toward the user device, versus the user device's alignment direction toward the base station, will be ignored unless specifically called out. A commonly shared geographical coordinate system, such as the direction of north, will be assumed known by the base station and the user device, so that they can specify the alignment angle relative to the geographical coordinate system. The term “signal” may represent an amplitude, a power level, a power density, or other measure of transmitted or received beam intensity. The term “beam” has many closely-related usages, including: directionally transmitted energy, an angular distribution function of the transmitted energy, directionally received energy, and an angular distribution of the received energy. A “transmission beam” refers to directional transmitted energy, and a “reception beam” refers to directional receptivity (such as a receiver antenna's directional receptivity). “Coherent” refers to signal processing from two antennas using a single common clock or time-base. This is in contrast to the normal practice (termed “quasi-colocation”) in which each antenna calibrates its time-base according to a received signal, such as a demodulation reference transmitted by the user device, which adjusts each antenna's clock individually based on the reception. Such separate time-base calibration of the two antennas, based on incoming signals from the user device, would eliminate the very phase shift or timing difference that the present application is intended to measure. Hence the use of a common clock or time-base enables the measurement of the relative phase or timing of signals at the two antennas. If the base station must use separate clocks for the two antennas, then the base station may determine a time offset between the two clocks, and may include that offset in calculating the phase shift or timing difference between the received signals.

User devices and base stations can rapidly and efficiently determine the optimal beam direction for communication by aligning their transmission and reception beams using the disclosed resource-efficient procedures, resulting in substantially improved communications with less energy consumption, less background radiation and interference (due to the lower transmission power levels and the reduced angular space exposed), and improved network performance generally, according to some embodiments.

Terms herein generally follow 3GPP (third generation partnership project) standards, but with clarification where needed to resolve ambiguities. As used herein, “5G” represents fifth-generation, and “6G” sixth-generation, wireless technology in which a network (or cell or LAN Local Area Network or RAN Radio Access Network or the like) may include a base station (or gNB or generation-node-B or eNB or evolution-node-B or AP Access Point) in signal communication with a plurality of user devices (or UE or User Equipment or user nodes or terminals or wireless transmit-receive units) and operationally connected to a core network (CN) which handles non-radio tasks, such as administration, and is usually connected to a larger network such as the Internet. The time-frequency space is generally configured as a “resource grid” including a number of “resource elements”, each resource element being a specific unit of time termed a “symbol period” or “symbol-time”, and a specific frequency and bandwidth termed a “subcarrier” (or “subchannel” in some references). Symbol periods may be termed “OFDM symbols” (Orthogonal Frequency-Division Multiplexing) in references. The time domain may be divided into ten-millisecond frames, one-millisecond subframes, and some number of slots, each slot including 14 symbol periods. The number of slots per subframe ranges from 1 to 8 depending on the “numerology” selected. The frequency axis is divided into “resource blocks” (also termed “resource element groups” or “REG” or “channels” in references) including 12 subcarriers, each subcarrier at a slightly different frequency. The “numerology” of a resource grid corresponds to the subcarrier spacing in the frequency domain. Subcarrier spacings of 15, 30, 60, 120, and 240 kHz are defined in various numerologies. Each subcarrier can be independently modulated to convey message information. Thus a resource element, spanning a single symbol period in time and a single subcarrier in frequency, is the smallest modulated unit of a message. “Classical” amplitude-phase modulation refers to message elements modulated in both amplitude and phase, whereas “quadrature” or “PAM” (pulse-amplitude modulation) refers to separately amplitude-modulating two signals and then adding them with a 90-degree phase shift. The two signals may be called the “I” and “Q” branch signals (for In-phase and Quadrature-phase) or “real and imaginary” among others. A “sum-signal” is the vector sum of the I and Q branch signals, and corresponds closely to the raw received signal prior to separation of the I and Q branches. Standard modulation schemes in 5G and 6G include BPSK (binary phase-shift keying), QPSK (quad phase-shift keying), 16QAM (quadrature amplitude modulation with 16 modulation states), 64QAM, 256QAM and higher orders. Most of the examples below relate to QPSK or 16QAM, with straightforward extension to the other levels of modulation. QPSK is phase modulated but not amplitude modulated. 16QAM may be modulated according to PAM which exhibits two phase levels at zero and 90 degrees (or in practice, for carrier suppression, ±45 degrees) and four amplitude levels including two positive and two negative amplitude levels, thus forming 16 distinct modulation states. For comparison, classical amplitude-phase modulation in 16QAM includes four positive amplitude levels and four phases of the raw signal, which are multiplexed to produce the 16 states of the modulation scheme. Communication in 5G and 6G generally takes place on abstract message “channels” (not to be confused with frequency channels) representing different types of messages, embodied as a PDCCH and PUCCH (physical downlink and uplink control channels) for transmitting control information, PDSCH and PUSCH (physical downlink and uplink shared channels) for transmitting data and other non-control information, PBCH (physical broadcast channel) for transmitting information to multiple user devices, among other channels that may be in use. In addition, one or more random access channels may include multiple random access channels in a single cell. “CRC” (cyclic redundancy code) is an error-checking code. “RNTI” (radio network temporary identity) is a network-assigned user code. “SNR” (signal-to-noise ratio) and “SINR” (signal-to-interference-and-noise ratio) are used interchangeably unless specifically indicated. “RRC” (radio resource control) is a control-type message from a base station to a user device. “Digitization” refers to repeatedly measuring a waveform using, for example, a fast ADC (analog-to-digital converter) or the like. An “RF mixer” is a device for multiplying an incoming signal with a local oscillator signal, thereby selecting one component of the incoming signal.

In addition to the 3GPP terms, the following terms are defined herein. Although in references a modulated resource element of a message may be referred to as a “symbol”, this may be confused with the same term for a time interval (“symbol-time”), among other things. Therefore, each modulated resource element of a message is referred to as a “modulated message resource element”, or more simply as a “message element”, in examples below. A “demodulation reference” is a set of Nref modulated “reference resource elements” or “reference elements” modulated according to the modulation scheme of the message and configured to exhibit levels of the modulation scheme (as opposed to conveying data). Thus integer Nref is the number of reference resource elements in the demodulation reference. A “calibration set” is one or more amplitude values and/or phase values, which have been determined according to a demodulation reference, representing the predetermined modulation levels of a modulation scheme. Each modulation level in the calibration set may have a code or number associated with it, and the receiver can demodulate the message element by selecting the modulation level in the predetermined modulation level, in the calibration set, that most closely matches the observed modulation level of the message element, and then assigning that associated code or number to the message element. If each message element has more than one modulation level, such as amplitude and phase, then the two associated codes or numbers may be concatenated to form the demodulated message element. Generally the modulation scheme includes integer Nlevel predetermined amplitude or phase levels. “RF” or radio-frequency refers to electromagnetic waves in the MHz (megahertz) or GHz (gigahertz) frequency ranges. A “short-form demodulation reference” is a compact demodulation reference exhibiting, generally, the maximum and minimum amplitude or phase levels of a polarization scheme, so that the receiver can calculate the intervening levels by interpolation. The “sum-signal amplitude” is the magnitude of the sum of a quadrature I and Q signals as-received, such as the square root of the sum of the squares of the I and Q branch amplitudes. The “sum-signal phase” is the arctangent of the Q-branch amplitude divided by the I-branch amplitude (plus the I-branch phase, if non-zero). A “beam” is a directed electromagnetic transmission or reception signal, as opposed to an isotropic or non-directional transmission or reception. A “focused transmission beam” is a spatially narrow or directed energy transmission from a transmission antenna, and a “focused reception beam” is a spatially narrow sensitivity or directed receptivity distribution in a reception antenna. (Usually, the same physical antenna can be used for both transmission and reception, both wide-angle and narrowly focused beams, with appropriate electronics.) Beams may be generated by multi-element antennas using analog or digital means. As mentioned, “reciprocity” is assumed herein, whereby an optimal beam direction for transmission by a wireless entity is the same as an optimal beam direction for reception by that wireless entity. Directions, and the geographical angles representing them, may be used interchangeably. Signal strength or signal level may represent amplitudes, power such as received power or transmitted power density, or other measure of intensity.

Turning now to the figures, a first example shows, schematically, phased signals from a base station to enable user devices to select an optimal beam direction.

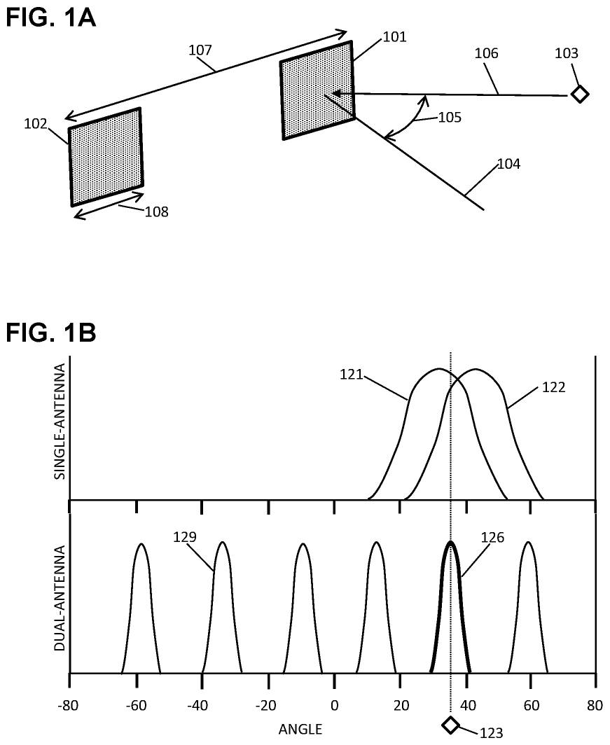

FIG. 1A is a schematic showing an exemplary embodiment of dual antennas, according to some embodiments. As depicted in this non-limiting example, a first antenna 101 and a second antenna 102 are configured for reception and for measuring the angle of arrival 105 of a transmission pulse 106 from a user device 103, relative to a perpendicular 104. (All of the figures are not-to-scale. The user device 103 is much farther from the antennas than the figure implies.) Both of the antennas 101, 102 are phased-array antennas in this case. Each phased-array antenna 101, 102 includes a multitude of separate reception elements, connected to analog or digital electronics for signal processing and phase determination. Each antenna 101, 102 has a width 108, and they are spaced apart to span a total distance 107.

To determine the alignment direction toward the user device, the base station can measure a phase or time in various reception elements of the phased-array antenna 101, such as elements at the right and left edges of the antenna, and determine a phase shift or timing difference between the two edges of the antenna, due to the time required for the wave to traverse that distance. According to the phase shift or timing difference, and the width of the antenna, the base station can determine a “single-antenna” angular probability distribution of the angle of arrival 105. For example, if the user device 103 is positioned directly in front of the antenna 101, along the perpendicular 104, then the transmission pulse would reach the entire antenna surface simultaneously, in which case the phase shift or timing difference, at opposite sides of the antenna 101, would be zero. Such a null measurement would indicate that the angle of arrival is zero degrees relative to the orthogonal 104. However, in the depicted case, the user device 103 is positioned at a larger angle 105, and therefore the pulse 106 reaches one edge of the antenna 101 sooner than the other edge, thereby causing a phase shift or time difference of the signal at the two edges of the antenna 101. Thus the phase shift or time difference between the two edges of the phased-array antenna provides a measure of the angle of arrival 105. In addition, the antenna 101 can determine the phase at many locations across the antenna 101, thus confirming the edge results. Analysis of this data determines an angular probability distribution of the angle of arrival, which is relatively broad because of the limited width 108 of the antenna 101. The maximum travel time across the antenna width 108 is generally very small, such as less than one nanosecond. In the presence of phase noise and timing jitter, the resulting angular probability distribution is generally less precise than required for efficient beam alignment; hence the need for two antennas. In the depicted example, the second antenna 102 is a similar phased-array antenna. The second antenna 102 can make the same measurement in the same way, and can independently determine a distribution of the angle of arrival 105, with about the same uncertainty as the first antenna 101. Slightly improved angular resolution can be obtained by averaging the two single-antenna distributions.

The base station can also analyze signals from the two antennas 101, 102 to determine a second measure of the angle of arrival. To do so, the base station can determine a phase or time of the pulse in one antenna, and then the phase or time in the second antenna, and thereby determine a difference in phase or time between the two antennas 101, 102 which is related to the angle of arrival 105. The base station can receive and analyze the pulse 106 signal in the two spaced-apart antennas 101, 102 coherently, using a common clock or time-base (that is, without a differential clock offset between the two antennas). Based on the difference in timing or phase between the two antenna signals, the base station can determine a series of possible angles of arrival (the “candidate angles”), according to the separation 107 and the frequency of the pulse 106.

The base station can then combine the two distributions for consistency, by selecting the candidate angle that matches the broad single-antenna distribution, and can thereby determine the angle of arrival. The base station can then calculate the alignment angle toward the user device by adding 180 degrees to the angle of arrival, correcting for the orientation of the antennas relative to geographical north, and can then transmit a message to the user device, informing it of the alignment angle.

FIG. 1B is a chart showing an exemplary embodiment of an angle of arrival as measured by the antennas of FIG. 1A, according to some embodiments. As depicted in this non-limiting example, two antennas detect a transmission pulse from a user device 123 located at a particular angle (about 35 degrees in this case). Each of the two antennas can determine a phase or time associated with the pulse at the two lateral edges of the antenna, and the base station can subtract those measurements to determine a phase shift or timing difference across each of the antennas, and can thereby determine a relatively broad angular probability distribution of the angle of arrival. The figure shows two broad distributions 121 and 122 in the “single-antenna” portion of the chart. These are the angular probability distributions determined by the two antennas separately, each based on a comparison of the signal phase or timing at the two edges of the antenna. The two distributions 121, 122 are not exactly the same because of noise or interference or other factors which may affect each antenna signal differently. The distributions 121, 122 are relatively broad because phased-array antennas for wireless communication are generally compact; hence the time required to traverse the width is quite short, and the small phase shift or timing difference is difficult to measure precisely, especially in the presence of noise and jitter.

The base station can measure the same incoming wave in the two spaced-apart antennas simultaneously, and can thereby determine a phase shift or timing difference between signals at the two antennas. A number of candidate angles are consistent with the measured phase shift or timing difference, based on the separation distance between the antennas and the wavelength of the transmission. The candidate angles 129 are shown in the “dual-antenna” portion of the chart. Multiple candidate angles 129 are found because there are multiple angles at which the measured phase shift or timing difference could be produced in the two antennas. Since phase is a circular parameter, the phase difference alone cannot determine how many wavelengths have passed between the two antenna receptions. Therefore, the dual-antenna distribution includes multiple candidate angles, each candidate angle being consistent with the measured phase shift or timing difference. The uncertainty of each candidate angle 129 determination is substantially narrower than the broad angular probability distributions 121, 122 of the single-antenna measurements, because the distance spanned by the two antennas is larger than the width of a single antenna, and the larger distance provides greater precision in the angular determination.

The base station can readily select the one candidate angle 126 (bolded) which is consistent with the single-antenna distributions 121, 122 by comparison. Then, using that best-matching candidate angle 126 as the angle of arrival, the receiver can calculate the alignment angle toward the user device relative to a universal coordinate system such as geographical north. The example shows that the base station, by selecting the dual-antenna candidate angle that best matches the single-antenna distribution, can thereby determine the angle of arrival, and hence the alignment angle toward the user device 123, with the narrower uncertainty provided by each candidate angle.

It may be noted that coherent analysis of signals from two separate antennas is not the way multi-antenna reception is usually done. Normally, in a process of “quasi-colocation”, each antenna (or its associated electronics) is calibrated to a local clock based on a received signal, such as a demodulation reference transmitted by the user device, or to a common clock with an antenna-specific time offset. The two antennas adjust their timing to the incoming signal, intentionally eliminating the angle-dependent phase or timing difference, so that subsequent message signals in the two antennas can be easily combined. However, this eliminates the very phase shift or timing difference that the present application seeks to measure. Therefore, in the present application, the two antennas are configured to use either synchronized clocks with no relative offset, or alternatively a single shared time-base, or other suitable timing coordination that exposes the relative phase shift or timing difference between the two antennas.

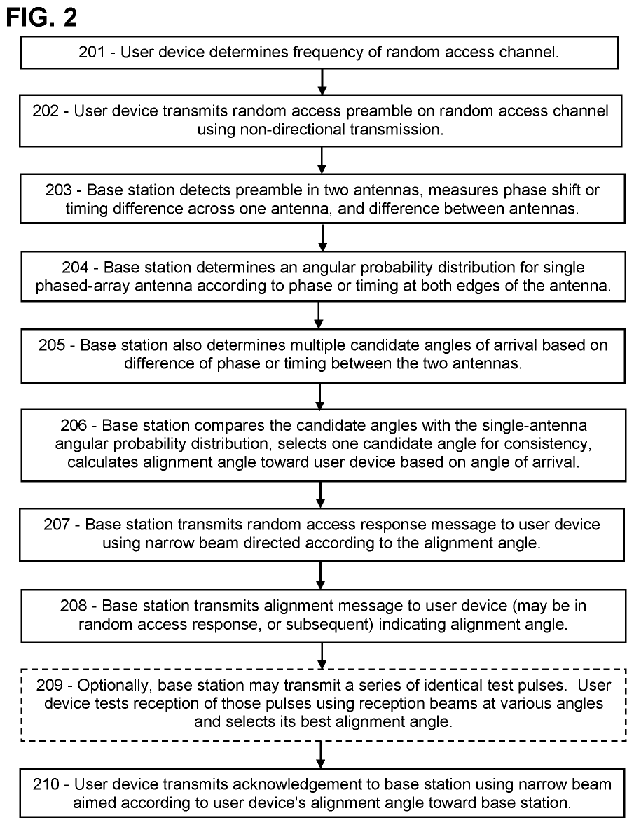

FIG. 2 is a flowchart showing an exemplary embodiment of a procedure for a base station to determine a user device alignment direction during initial access, according to some embodiments. As depicted in this non-limiting example, at 201 a user device determines the frequency and other parameters of a random access channel (or other entry channel) of a base station, and at 202 transmits an entry-request message, such as a random access preamble, on that channel. (In another embodiment, the entry request may be a single pulse occupying a single resource element, at a time and frequency allocated for such requests.) The entry request message is generally transmitted non-directionally, since the user device presumably does not yet know the direction toward the base station. However, if the user device does know or guess the alignment angle toward the base station (from a database or a previous registration for example), then the user device can configure its own transmission beam to include the presumed location of the base station.

At 203, the base station detects the entry request message in two spaced-apart antennas, at least one of which is a phased-array antenna with multiple reception elements. The base station has previously configured the two antennas to process incoming signals according to a common clock, or otherwise determine a relative phase shift or timing difference between the receptions at the two antennas. The base station then determines a relatively broad single-antenna angular probability distribution based on reception signals observed by various reception elements of the phased-array antenna, such as a difference between signals detected at opposite edges of the phased-array antenna. In addition, at 204 (which is simultaneous with 203), the base station compares signals from the two spaced-apart antennas, and determines a phase shift or timing difference between them. At 205 determines a dual-antenna distribution including a plurality of candidate angles of arrival, each of which is consistent with the phase shift or timing difference between the two antennas.

At 206, the base station compares the single-antenna and dual-antenna angular distributions, and determines that one of the candidate angles most closely matches the broad single-antenna angular probability distribution, and therefore is most likely the angle of arrival of the entry-request message. (Alternatively, the base station can determine the most probable angle of arrival as a weighted average, or other fit, of the single-antenna and dual-antenna distributions, weighted according to the width of each distribution.) The base station can then determine the alignment angle toward the user device by adding or subtracting 180 degrees to the angle of arrival, and correcting the angle according to the orientation of the antennas relative to a geographical reference such as north. The base station at 208 transmits a reply message 207 to the user device indicating the alignment angle toward the user device relative to the geographical reference. (Alternatively, the base station could report a suggested alignment angle from the user device toward the base station, which differs by 180 degrees. The user device is expected to know, from standards for example, whether the base station reports the base station's alignment angle toward the user device, or the user device's alignment angle toward the base station.)

The reply message may be included as part of the random access sequence. For example, an indication of the alignment angle may be added to the RAR (random access response) message, or the Msg4 (message 4 of the random access response), or MsgB (second message of 2-stage entry process), or a later message following the initial access procedure. For compactness, the alignment angle may be encoded or multiplexed or “piggy-backed” in another message, such as the RAR or Msg4 or MsgB or other message from the base station to the user device. Preferably the reply message is aimed at the user device according to the newly determined alignment angle. Preferably the user device transmits subsequent uplink messages 210 according to the user device's alignment angle toward the base station.

Optionally, at 209, the base station can transmit some number of identical test pulses, such as 3 or 6 or 10 identical test pulses, sequentially toward the user device, each with the same amplitude and frequency and modulation and direction. The identical test pulses may be appended to the reply message or another message, or they may be transmitted as a separate message. The user device can detect these identical test pulses using a variety of directional reception beams aligned in different directions, thereby scanning the reception direction around the suggested alignment angle. The user device can select the best beam direction for signal quality, thereby obtaining an even more advantageous reception beam direction than that suggested by the base station. Differences in the optimal alignment angles determined by the two entities, may be due to some electromagnetic nonuniformity in the signal path. There is generally no need for the user device to inform the base station of the user device's preferred alignment choice. Instead, the user device may transmit a message to the base station indicating the signal quality observed by the user device with its optimal reception beam direction. The base station can then adjust the downlink transmission power accordingly.

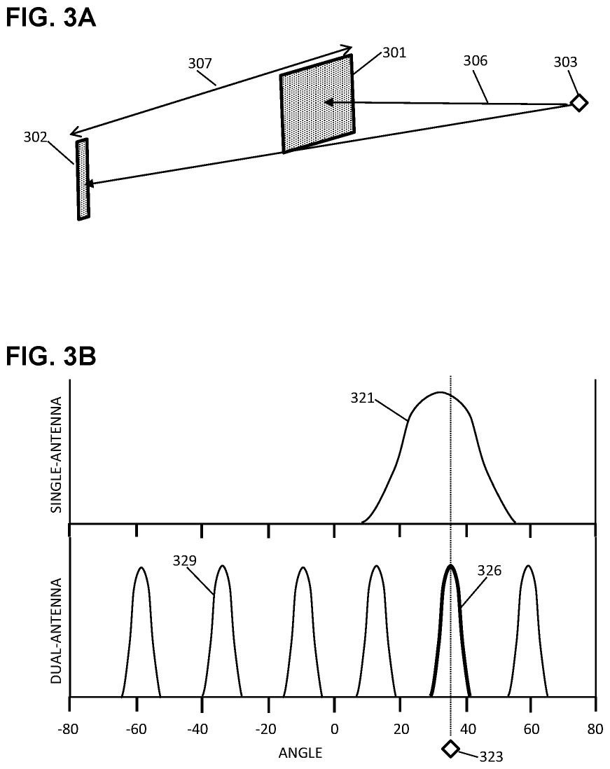

FIG. 3A is a schematic showing an exemplary embodiment of a dual-antenna system with asymmetric antennas, according to some embodiments. As depicted in this non-limiting example, two antennas 301 and 302 of a base station are spaced apart by a distance 307, and are configured to receive a transmission 306 from a distant user device 303. The first antenna 301 is a phased-array antenna including a large number of independently-processed reception elements, and the second antenna 302 is a non-directional non-phased-array antenna configured to receive the transmission 306 simultaneously with the first antenna 301. The base station can analyze signals from various reception elements of the phased-array antenna 301, and can determine a phase shift or timing difference between elements on opposite sides of the phased-array antenna 301. The base station can then determine a relatively broad single-antenna angular probability distribution of the angle of arrival based on those signals, as well as the reception signals of other reception elements within the phased-array antenna 301.

The base station can also compare signals in the first and second antennas 301, 302, using a single clock or time-base for processing the signals, and can thereby determine a phase shift or timing difference between the received signals of the two antennas 301, 302. The base station can then determine a dual-antenna probability distribution including a plurality of candidate angles of arrival, each candidate angle being consistent with the observed phase shift or timing difference between the two antennas. The base station can then select whichever of the candidate angles most closely matches the single-antenna distribution. The angular uncertainty of the single-antenna distribution is related to the width of the phased-array antenna 301, whereas the uncertainty of each candidate angle is related to the separation distance 307 between the two antennas 301, 302, which is generally much larger than the width of the phased-array antenna 301. The angular uncertainty is inversely related to the distance between the two signal receptions; hence each candidate angle has a narrower probability distribution than the broad single-antenna distribution. The combination of the single-antenna and dual-antenna distributions can therefore provide greater precision than the single-antenna distribution alone.

The example demonstrates that it is not necessary for the two antennas to be matched, nor even that they both be phased-array antennas, as long as they both detect the user device's transmission at the same time.

FIG. 3B is a chart showing an exemplary embodiment of an angle of arrival as measured by the antennas of FIG. 3A, according to some embodiments. As depicted in this non-limiting example, an asymmetric pair of antennas includes a phased-array antenna and a separate non-directional antenna, detecting an alignment pulse from a user device 323. First, a relatively broad single-antenna angular probability distribution 321, shown on the “single-antenna” portion of the chart, is based on the phase or time of the pulse detected in various detection elements of the phased-array antenna. Second, reception signals from the two antennas can be analyzed differentially, using a common clock or time-base, thereby determining a phase shift or timing difference between receptions at the two antennas. From that phase shift or timing difference, the base station determines a plurality of candidate angles 329, shown in the “dual-antenna” portion of the chart, each candidate angle having a relatively narrow angular distribution as shown. One of the candidate angles 326 (bolded) is closest to the single-antenna distribution 321, and therefore is selected as the best determination of the angle of arrival. The base station can then calculate the alignment angle toward the user device 323 relative to geographical north, for example.

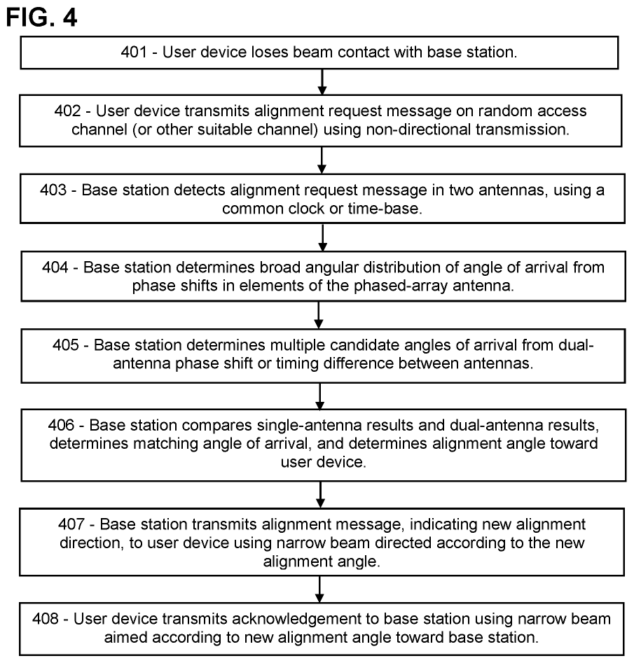

FIG. 4 is a flowchart showing an exemplary embodiment of a procedure for a user device to request re-alignment after losing beam contact with a base station, according to some embodiments. As depicted in this non-limiting example, at 401 a user device, which had been previously communicating with the base station on directed transmission and reception beams, loses “beam contact” or reception quality. To redetermine the alignment direction, at 402 the user device transmits an alignment request message to the base station, using either a broad transmission beam or an isotropic non-directional transmission, to ensure that the base station can receive it.

At 403, the base station detects the alignment request message in two spaced-apart antennas, at least one of which is a phased-array antenna, coherently using a common clock or time-base for signal processing of the two antennas. In one embodiment, the base station can configure the two antennas for coherent signal processing of each message received at a time and frequency reserved for such alignment requests by default. In another embodiment, the base station can configure the two antennas for coherent signal analysis upon receiving the alignment request, and can then instruct the user device to transmit an alignment pulse for directional analysis.

At 404, the base station can determine a relatively broad angular probability distribution of the angle of arrival, based on a phase shift or timing difference between receptions at various elements of the phased array antenna. At 405, the base station can determine a plurality of candidate angles of arrival based on a phase shift or timing difference in signals received at the two spaced-apart antennas. At 406, the base station can select which one of the candidate angles matches the single-antenna distribution, and can thereby determine the updated alignment angle relative to north.

At 407, the base station can transmit an alignment message to the user device, using a narrow transmission beam at the updated alignment angle. At 408 the user device acknowledges, also using the updated alignment angle for transmission.

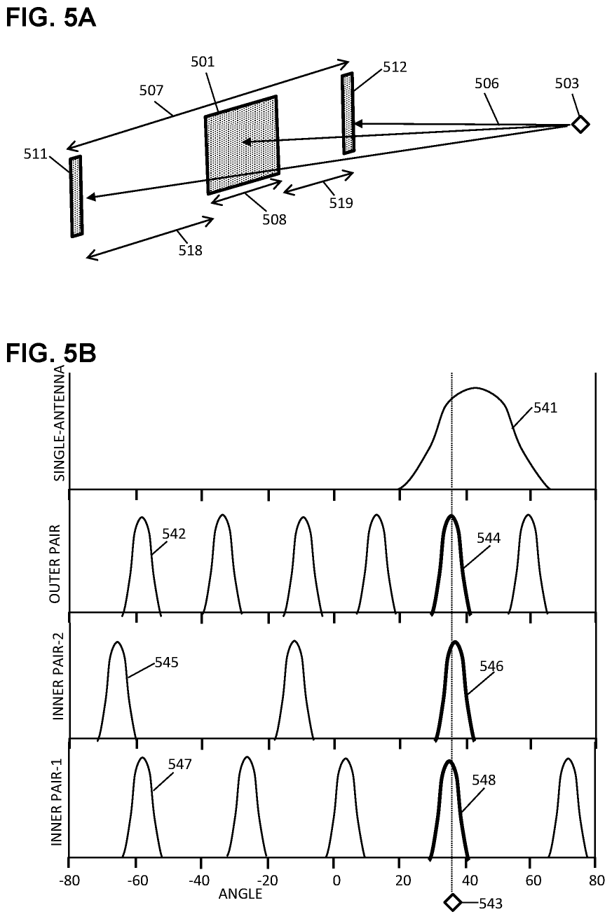

FIG. 5A is a schematic showing an exemplary embodiment of three spaced-apart antennas, according to some embodiments. As depicted in this non-limiting example, a base station uses three spaced-apart antennas to determine the angle of arrival of an incoming signal, and then determines the alignment angle toward a user device. The three antennas include, in this case, one phased-array antenna 501 which is straddled by two spaced-apart non-directional antennas 511, 512. The phased-array antenna 501 has a width 508, and the non-directional antennas 511, 512 are spaced apart by a distance 507. The first non-directional antenna 511 is spaced apart from the phased-array antenna 501 by distance 518, and the second non-directional antenna 512 is spaced apart from the phased-array antenna by distance 519. The antennas 501, 511, 512 simultaneously detect an alignment pulse 506 from a user device 503, using a common clock or time-base.

The base station can determine a single-antenna angular probability distribution, based on a phase shift or timing difference between reception signals received at the left and right edges of the phased-array antenna 501. Since the pulse 506 reaches one edge of the phased-array antenna slightly sooner than the other edge, the first and second edges produce slightly different reception signals, with the second edge reception signal shifted in time or phase relative to the first edge. Other reception signals from the interior regions of the phased-array antenna 501 can be similarly analyzed using suitable electronics. Then, the base station can determine the angular probability distribution of the arrival angle according to that phase shift or timing difference, the width 508 of the phased-array antenna, and the frequency of the alignment pulse 506. Due to the limited width of practical communication antennas, the phase shift or timing difference is generally very small, and hence the angle of arrival is generally determined with substantial uncertainty. The angular distribution representing the range of angles of arrival, consistent with the single-antenna phase or timing distributions, is therefore relatively broad in general.

The base station can also determine the angle of arrival using the two spaced-apart non-directional antennas 511, 512 by measuring a phase shift or timing difference between the reception signals of those antennas 511, 512. Based on the phase shift or timing difference, and the separation distance 507, and the frequency, the base station can then determine a dual-antenna distribution consisting of a plurality of candidate angles of arrival. Each candidate angle is consistent with the observed phase shift or timing difference across the antenna separation 507, including an unknown number of whole wavelengths between the antennas. The single-antenna distribution does not have that ambiguity because the phased-array antenna 501 includes a very large number of separately-processed reception elements at various positions across the phased-array antenna 501, and those reception elements together tend to cancel probabilities outside of the single-antenna distribution as shown. On the other hand, the uncertainty of the candidate angles is substantially narrower than the single-antenna distribution, due to the separation distance 507 being larger than the antenna width 508.

The base station can then compare the single-antenna distribution with the plurality of candidate angles, select one of the candidate angles that best matches the single-antenna distribution, and thereby determine the alignment angle with a relatively high precision.

For further disambiguation and additional error cancellation, the base station can calculate other candidate angles based on different antenna pairs. For example, the base station can determine a second plurality of candidate angles according to a phase shift or timing difference between the phased-array antenna 501 and the first non-directional antenna 511, and a third plurality of candidate angles according to a phase shift or timing difference between the phased-array antenna 501 and the second non-directional antenna 512. The second plurality of candidate angles are distributed in angle based on the separation 518 between the phased-array antenna 501 and the first non-directional antenna 511, while the third plurality of candidate angles are distributed in angle based on the separation 519 between the phased-array antenna 501 and the second non-directional antenna 512. Those two separations may be different, depending on how the various antennas are positioned.

As an option, the base station may calculate the angle of arrival according to a weighted average of the single-antenna distribution and the closest candidate angle of the dual-antenna distribution (as well as the other combinations mentioned), the various angles being weighed inversely according to the width of their angular distributions. The base station can then determine the alignment direction toward the user device 503 by adding or subtracting 180 degrees to the best-fit angle of arrival, and then adjusting for the orientation of the antenna 501 relative to geographical north (or other coordinate system that the user device can recognize). The base station can then send an alignment message to the user device (preferably beamed at the newly-calculated alignment angle), indicating the base station's alignment angle toward the user device or, more preferably, the same plus 180 degrees which is the suggested alignment angle for transmissions from the user device to the base station.

As a further option, the base station can then transmit a plurality of identical test pulses to the user device, all at the same amplitude and frequency and modulation and direction, so that the user device can align its reception beam by testing reception quality at various angles near and around the alignment angle that was suggested by the base station.

FIG. 5B is a chart showing an exemplary embodiment of an angle of arrival as measured by a phased-array antenna and two spaced-apart non-directional antennas, such as those of FIG. 5A, according to some embodiments. As depicted in this non-limiting example, the phased-array antenna provides a relatively broad single-antenna angular probability distribution 541 of the angle of arrival, which is determined according to a phase shift or timing difference measured across the reception elements of the phased-array antenna, and according to a separation distance between those elements. In addition, as indicated in the line “outer pair”, the two non-directional antennas determine a first plurality of candidate angles 542 according to the separation between the spaced-apart antennas. The candidate angles 542 have a narrower probability distribution than the single-antenna distribution 541 because the separation between the non-directional antennas is generally greater than the width of the phased array antenna, and therefore enables higher angular precision. However, the dual-antenna distribution 542 includes several candidate angles 542, each consistent with the phase shift or timing difference observed between the two non-directional antennas. The base station can select a particular candidate angle 544 which is consistent with the broader single-antenna distribution 541, and thereby determine the angle of arrival.

In addition, for even greater disambiguation, the base station can calculate a second plurality of candidate angles 547 according to a phase shift or timing difference measured between the phased-array antenna and a first non-directional antenna. This second plurality is shown as “inner pair-1”. Furthermore, the base station can calculate a third plurality of candidate angles 545 according to a phase shift or timing difference measured between the phased-array antenna and a second non-directional antenna. This third plurality is shown as “inner pair-2”. Each plurality 542, 545, 547 can have a different distribution with a different angular separation between candidate angles, based on the associated antenna separations. However, one particular candidate angle in each plurality corresponds to the same wave feature arriving at each of the three antennas in turn, and those candidate angles are generally consistent with each other and with the single-antenna distribution. In the example, the corresponding candidate angles, matching the single-antenna distribution 541, are bolded as 544, 546, and 548. The base station can then include, in a maximum-likelihood or least-squares fit, or other fit or analysis, the three selected candidate angles (inversely weighted by their widths) and the single-antenna distribution (also inversely weighted by its width), and thereby determine a best-fit value for the alignment angle. Finally, to determine the alignment angle toward the user device 543, the base station can add or subtract 180 degrees, and then relate that value to a geographical direction such as north.

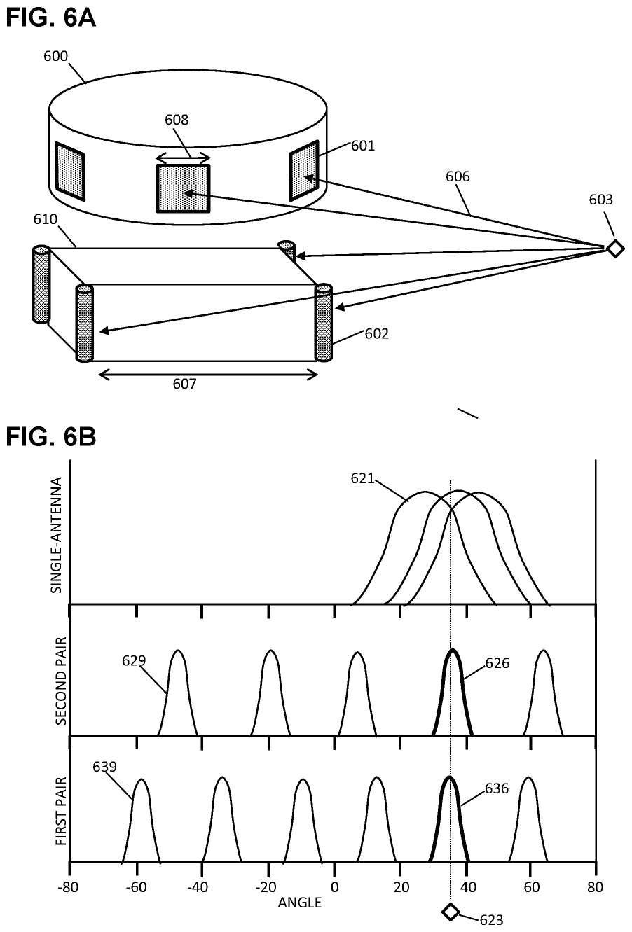

FIG. 6A is a schematic showing an exemplary embodiment of multiple spaced-apart antennas, according to some embodiments. As depicted in this non-limiting example, a base station includes an array of phased-array antennas 601 mounted on a structure 600 such as a water tower, each phased-array antenna 601 having a width 608, and each facing a different direction as shown. The base station also has a secondary structure 610 (which may be the same water tower) holding a plurality of non-directional or non-phased-array antennas 602, spaced apart by a distance 607. The antennas 601, 602 receive a transmission pulse 606 from a user device 603, such as an alignment pulse consisting of a single resource element containing modulated electromagnetic energy, in this case. (The user device 603 is much more distant than can be depicted here.)

The base station can use the antennas 601, 602 to determine the direction toward the user device 603. The base station can determine a relatively broad single-antenna angular probability distribution of the angle of arrival, for each of the phased-array antennas 601 that is positioned to receive the pulse 606. Each single-antenna distribution can be determined according to a phase shift or timing difference of the pulse 606, as received at two edges of the phased-array antenna 601.

The base station can simultaneously determine, for each pair of the non-directional antennas 602, a dual-antenna angular distribution including a plurality of candidate angles. The candidate angles are determined according to the separation distance 607 between the pair of non-directional antennas 602, the orientation of the pair relative to the angle of arrival, and the frequency of the transmission 606. For example, if two pairs of non-directional antennas 602 are able to detect the incoming transmission 606, then the base station can determine two separate sets of candidate angles.

In addition, the base station can determine additional candidate angles by comparing signals in one of the phased-array antennas 601 with signals in one of the non-directional antennas 602. Further combinations may be possible, depending on the installation.

The base station can then determine the alignment direction according to a fit of the various single-antenna distributions and the various dual-antenna candidate angles, and can thereby select a maximum-likelihood angle of arrival of the transmission pulse from the user device 603.

FIG. 6B is a chart showing an exemplary embodiment of an angle of arrival as measured by antennas such as those of FIG. 6A, according to some embodiments. As depicted in this non-limiting example, the base station detects a pulse from a user device 623 and determines three broad single-antenna angular probability distributions 621 of the angle of arrival, based on reception signals in three of the phased-array antennas. Also shown are two sets of dual-antenna candidate angles of arrival 629 and 639, determined from two pairs of the non-directional antennas. The two sets of candidate angles 629 and 639 have different angular spacings because the two pairs of non-directional antennas have different separation distances, as viewed by the incoming alignment pulse. In this case, the “first pair” of non-directional antennas has a smaller separation, as viewed by the incoming alignment pulse, than the “second pair” of non-directional antennas, and hence the candidate angles indicated by the first pair are closer together than the candidate angles of the second pair, as shown. This mismatch between the two sets of candidate angles may be advantageous since it simplifies the task of determining which candidate angles 626, 636 correspond to the single-antenna distributions 621. Further pairings may be possible, such as pairs of the phased-array antennas, but are omitted here for simplicity. The base station can determine the angle of arrival as a weighted average or maximum-likelihood fit, or other fit, to the various distributions, including the three single-antenna distributions 621 inversely weighted according to their widths, and the two closest candidate angles 626, 636 inversely weighted according to their widths. The base station can then determine the alignment angle toward the user device in a geographical grid, such as relative to north.

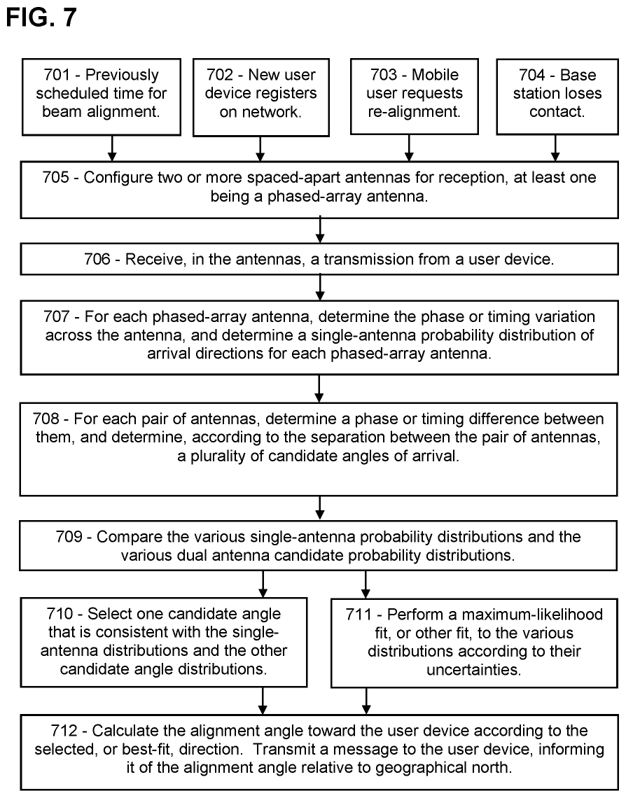

FIG. 7 is a flowchart showing an exemplary embodiment of a procedure for a base station to process signals from multiple antennas, according to some embodiments. As depicted in this non-limiting example, an alignment session may be triggered by various events such as: 701 a semi-persistently scheduled time for user devices to transmit a pulse on a preassigned frequency, if they choose to do so; 702 a new user has registered, or requests entry into, the network; 703 a mobile user device has moved or rotated and therefore has lost beam alignment; or 704 the base station or a user device has determined that beamed communication has been broken, among other possible triggering scenarios.

At 705, the base station configures two or more antennas, including at least one phased-array antenna, to receive the alignment pulse or pulses synchronized by a common clock or time-base. At 706, the base station receives at least one alignment pulse, and at 707 determines a single-antenna angular distribution according to phase shifts or timing differences reported by various detection elements of the phased-array antenna. At the same time, at 708, the other spaced-apart antenna, which may be non-directional, also receives the alignment pulse, from which the base station can determine another phase shift or timing difference between the two antenna signals, and thereby calculate a dual-antenna distribution including a plurality of candidate angles, according to the separation between the antennas, the frequency, and the phase shift or timing difference observed.

At 709, the base station can compare the single-antenna angular probability distribution of angle of arrival, with the dual-antenna distribution of candidate angles of arrival. The base station can select the candidate angle most closely matching the single-antenna distribution at 710, or alternatively can perform a maximum-likelihood fit, or other fit, of the various distributions to determine an angle of arrival of the pulse at 711. If further antennas are present and can provide further phase or time data, then the selection or fit can include those measurements or distributions as well. At 712, the base station can determine the alignment angle toward the user device relative to geographical north, and can transmit that result to the user device.

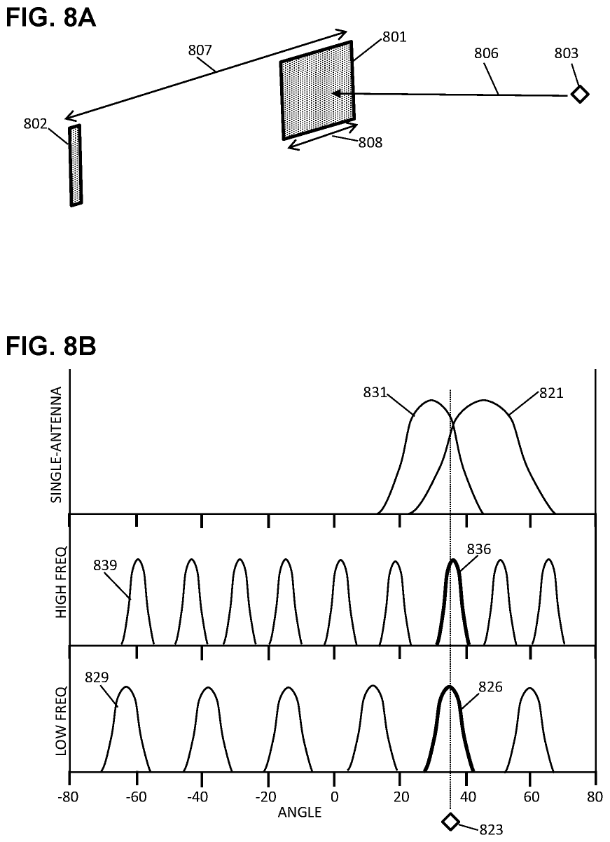

FIG. 8A is a schematic showing an exemplary embodiment of antennas for angle determination using multiple frequencies, according to some embodiments. As depicted in this non-limiting example, two alignment pulses are transmitted by the user device 803, at two widely different frequencies. In one example, the first pulse may be 1.5 times higher in frequency than the second pulse, or the frequencies may have a larger or smaller ratio such as 1.2:1 or 5:1 depending on implementation. The two frequencies generate two different single-antenna angular distributions and two different dual-antenna angular distributions, according to the wavelengths of the transmitted pulses. The angle of arrival can then be found according to a weighted fit of the various angular distribution functions.

In the depicted case, a phased-array antenna 801 with a width 808, and a non-directional antenna 802, are mounted spaced apart by a distance 807, and configured to detect alignment pulses 806 from a user device.

The antennas 801, 802 detect the first pulse which is transmitted at the first frequency. The base station can determine a first single-antenna angular probability distribution from a phase shift or time difference between detection elements across the phased-array antenna, on the first pulse. The base station can also calculate a first dual-antenna distribution, including a plurality of candidate angles of arrival, according to a phase shift or timing difference between the two spaced-apart antennas and the first frequency.

The base station can then detect the second pulse which is transmitted at the second frequency. The base station can determine a second single-antenna angular probability distribution from a phase shift or timing difference registered in detection elements across the phased-array antenna on the second pulse. The base station can also calculate a second dual-antenna distribution according to a phase shift or timing difference between the two spaced-apart antennas, and can determine a second plurality of candidate angles according to the second frequency.

The two single-antenna distributions, acquired from pulses at different frequencies, will generally have different widths due to the different frequencies, and slightly different centroids due to random noise. The two sets of candidate angles are also expected to be different, especially in their widths and their angular spacings, due to the difference in frequency.

The base station can then select the best-fit angle of arrival according to the first and second single-antenna and dual-antenna distributions, and thereby determine the alignment direction toward the user device relative to geographical north. The two frequencies, by generating different distributions, may enhance the precision of the alignment angle thereby determined.

In some embodiments, especially at high multi-tens of GHz frequencies, the optimal alignment direction may depend on the frequency, due to reflections and other nonuniformities in the beam path. In that case, the base station may weight the first and second candidate angles differently when calculating the angle of arrival, for example by weighting-up whichever pulse has a frequency closer to the planned communication frequency, and weighting-down the candidate angles of the other frequency.

FIG. 8B is a chart showing an exemplary embodiment of an angle of arrival as measured using multiple frequencies, according to some embodiments. As depicted in this non-limiting example, the angular distributions resulting from the antenna configuration of FIG. 8A are shown, for single-antenna and dual-antenna receptions, using a higher frequency pulse and a lower frequency pulse transmitted by the user device 823, which is located at an alignment angle of about 35 degrees as shown.

On the “single-antenna” line, two relatively broad single-antenna angular distributions are shown, determined by the base station according to a phase shift or timing difference between signals detected at various regions of the phased-array antenna 801. A first distribution 821 is determined from an alignment pulse at a first frequency, and a second distribution 831, slightly narrower, is determined from a second pulse at a second (higher) frequency. Higher frequencies generally result in narrower angular distributions. The two distributions 821, 831 have different centroids because of noise. The single-antenna angular measurement is difficult because the time required for the incoming wave to traverse the phased-array antenna is usually a very short time, such as a fraction of a nanosecond, which may be comparable to the effects of noise and interference.

On the “low freq” line of the chart, a dual-antenna distribution is shown for the first (lower) frequency, including a first series of candidate angles 829, rendered as narrow angular distributions. The candidate angles 829 are determined by a phase shift or timing difference between reception signals at the two antennas on the first pulse. One of the candidate angles 826 (bolded) is closest to an average (such as a weighted average according to uncertainty) of the two single-antenna distributions 821, 831.

On the “high freq” line, another dual-antenna distribution is shown, this time for the higher frequency second pulse. The candidate angles 839 have narrower uncertainty distributions than those 829 for the lower frequency pulse, because higher frequencies have shorter wavelengths, and therefore a sharper angular determination based on the phase shift or timing difference between the two antennas, in general. The second plurality of candidate angles 839 are also more closely spaced than the first candidate angles 829 because, at the higher frequency, a smaller angular change results in a full wavelength change in the distance traveled by the pulse. As before, the bolded candidate angle 836 is most closely matching the single-antenna distributions 821, 831. The selected candidate angles 826, 836 of the two frequencies are at slightly different angles due to noise and interference.

The base station can analyze these distributions and determine a best-fit value for the angle of arrival. For example, the base station can perform a weighted average among the two single-antenna distributions 821, 831 and the two closest candidate angles 826, 836, weighted according to the width of each distribution. Alternatively, the base station can perform a maximum-likelihood analysis, while optionally discarding one of the distributions as an outlier. Many other analysis procedures are possible and are foreseen, the output of which is the best-fit value for the angle of arrival. As mentioned, if one of the pulse frequencies close to the planned communication frequency, then the angular distributions for that closer frequency pulse may be weighted heavier than the other frequency's distributions.

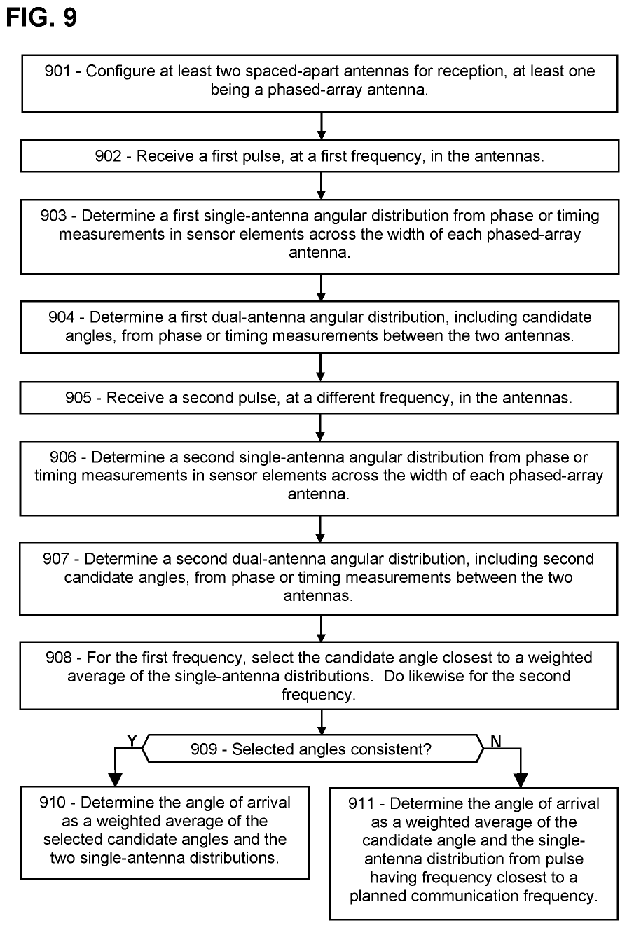

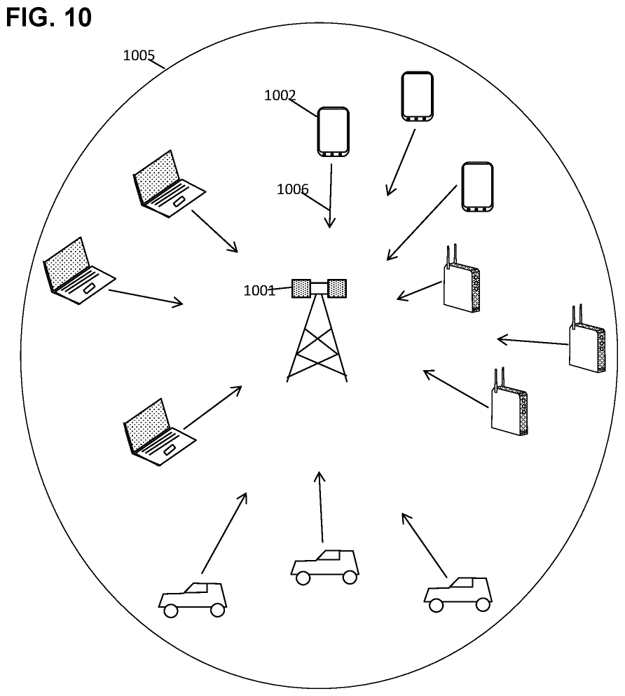

FIG. 9 is a flowchart showing an exemplary embodiment of a procedure for a base station to determine an angle using multiple frequencies, according to some embodiments. As depicted in this non-limiting example, a base station determines the angle of arrival of pulses transmitted at two frequencies by a user device.

At 901, the base station configures two spaced-apart antennas, of which at least one is a phased-array antenna, for detection of alignment pulses from the user device using a common clock or time-base for the two antennas, that is, without adjusting each antenna's electronics separately to a received demodulation reference or other incoming signal. However, if the two antennas include local clocks which are already timed to incoming signals, then the base station can determine an offset or difference between the two antenna clocks, and can include that difference in the subsequent phase shift or timing determinations. In this example, a common time-base is assumed.

At 902, the antennas receive a first pulse transmitted at a first frequency, and at 903 each phased-array antenna measures a phase shift or timing difference at the two lateral edges of the antenna. The base station thereby determines a first angular probability distribution of the angle of arrival, based on the antenna width and the first frequency. At 904, using the same pulse, the base station determines a dual-antenna distribution according to a phase shift or timing difference between receptions at the two antennas. The dual-antenna distribution includes a first plurality of candidate angles, each with a relatively narrow distribution according to the first frequency and the separation of the two antennas.

At 905, the antennas receive a second pulse at a second frequency, and at 906 the phased-array antenna determines a second single-antenna distribution. At 907, the base station determines a second dual-antenna distribution including a second plurality of candidate angles, according to the second frequency.

At 908, the base station selects the candidate angle of the first plurality which is closest to the single-antenna distributions, and also the candidate angle of the second plurality that is closest to the single-antenna distributions. At 909, the base station determines whether the two selected candidate angles, at the two frequencies, are consistent with each other according to the widths of the two candidate angle uncertainties. If they are consistent (such as overlapping each other by a predetermined amount, or other mathematical criterion for consistency between distributions), then at 910 the base station determines the angle of arrival according to a fit of the two selected candidate angles. Optionally, the base station may include the two single-antenna distributions, weighted inversely according to width, and may thereby determine the alignment angle toward the user device. However, if the selected candidate angles, at the two frequencies, are not consistent with each other at 909, then at 911 the base station can determine which of the first and second frequencies is closer to a planned frequency for communications with the user device. The base station can determine the angle of arrival according to the candidate angle of that closer frequency, discarding the other measurements. Alternatively, the base station may include the selected candidate angles of both frequencies, by suitably de-weighting the frequency that is farther from the intended communication frequency.

FIG. 10 is a schematic showing an exemplary embodiment of a wireless network with dual-antenna beam alignment, according to some embodiments. As depicted in this non-limiting example, a base station, with a plurality of spaced-apart antennas 1001 (only two showing, at least one of which is a phased-array antenna), is in communication with a number of user devices 1002, in a wireless network 1005. Each user device transmits an alignment pulse 1006 (which may be a single resource element of transmission in a predetermined symbol-time on a predetermined subcarrier). The base station antennas 1001 receive the various pulses 1006 and determine an alignment angle for each user device. For example, the base station may determine, for each pulse 1006, a relatively broad angular probability distribution of the angle of arrival of the pulse 1006, based on a phase shift or timing difference in detection elements of the phased-array antenna. The base station may also, at the same time, determine a set of candidate angles based on a phase shift or timing difference between the two spaced-apart antennas 1001. The base station can then select whichever one of the candidate angles most closely matches the single-antenna angular probability distribution, and by correcting for the orientation of the antennas 1001 in a geographic coordinate system, can determine the alignment direction for each of the user devices 1002 in the network 1005.

In some embodiments, the base station may repeat the alignment procedure and update the alignment directions on a periodic schedule, such as as semi-static assignment of, say, the first symbol-time of each frame or each second or each ten-second period, for user devices to transmit alignment pulses if they need the alignment service.

In some embodiments, the base station can inform the user devices 1002 of their suggested alignment angles by adding 180 degrees to the base station's alignment angle toward the user device, and transmitting an alignment message to each user device with that updated value after each alignment session. To avoid unnecessary signaling, the base station may inform only those user devices 1002 for which the suggested alignment direction has changed, thereby avoiding unnecessary messaging to the user devices that have had no change, or no significant change, in their alignment directions.

In some embodiments, the base station may transmit, after the alignment message or at some other predetermined time, a plurality of identical pulses, each pulse in one resource element for example. The user devices can detect those pulses using directional reception beams which are scanned across the suggested alignment direction, and can thereby fine-tune their own beam directions toward the base station.

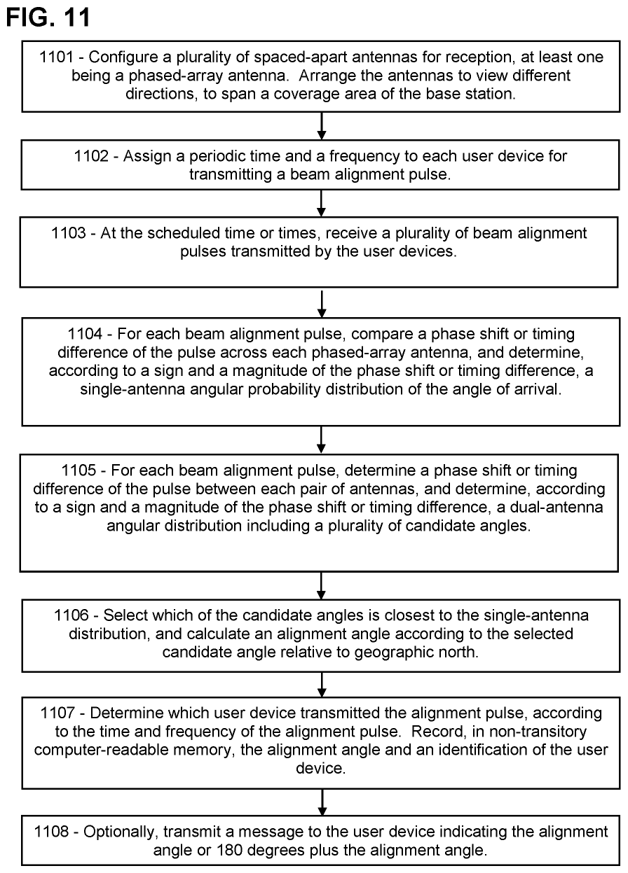

FIG. 11 is a flowchart showing an exemplary embodiment of a procedure for a base station to determine an alignment angle for each user device in a network, according to some embodiments. As depicted in this non-limiting example, a base station of a wireless network can determine the alignment direction of each user device in the network using a compact series of pulses, without iteration or repeated messaging. At 1101, the base station configures a plurality of antennas, including at least one phased-array antenna, for coherent reception, that is, for signal processing using a common clock or time-base that enables relative phase or timing measurements between the antennas. Enough antennas are provided and oriented in various directions, sufficient to cover the region that the base station is responsible for managing.

At 1102, the base station assigns, to each user device in the cell, an alignment pulse grant specifying a particular subcarrier and a periodically-recurring symbol-time. The user device can transmit an alignment pulse at that time and frequency, to request beam alignment service and to provide the alignment pulse. Then, at 1103, the base station receives the various alignment pulses transmitted by user devices that desire such service. Some of the user devices may not transmit pulses because they have recently re-aligned their beams, or have seen no loss of signal quality, or have not moved, or for other reason decline the service. Thus the base station receives pulses only from those user devices needing re-alignment.

At 1104, the base station determines a single-antenna angular probability distribution of the angle of arrival for each alignment pulse received, in each of the phased-array antennas, by comparing a phase shift or timing difference of the pulse in various reception elements of the antenna. At 1105, the base station determines a dual-antenna angular distribution for each pulse in each pair of antennas, including a plurality of candidate angles, by comparing the phase shift or timing difference of the pulse in the two antennas. At 1106, the base station compares the single-antenna and dual-antenna distributions, selects one of the candidate angles for consistency with the single-antenna distribution, and calculates an angle of arrival according to a fit or weighted average.

At 1107, the base station determines the alignment angle toward each participating user device relative to a geographical direction. The base station records the updated value in computer memory, and optionally, at 1108, transmits a message to the user device indicating the updated alignment angle. However, if the alignment angle to a particular user device is unchanged, or has changed only within a predetermined limit such as a fraction of the user device's beam width, then the base station may omit the message to that user device, to avoid wasting resources. The user device may be expected to interpret a lack of an alignment reply message as indicating that there is no change.

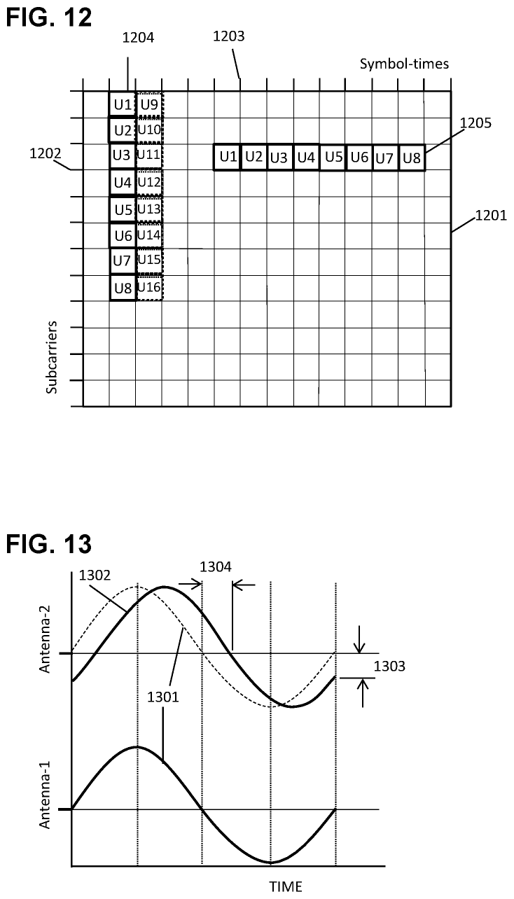

FIG. 12 is a chart showing an exemplary embodiment of a resource grid with multiple user device alignment pulses, according to some embodiments. As depicted in this non-limiting example, a resource grid 1201 is defined by subcarriers 1202 in frequency and symbol-times 1203 in time. Two regions 1204 and 1205 are allocated for user devices to transmit alignment pulses, one pulse per resource element. The first region 1204 is frequency-spanning, or occupying multiple subcarriers at a single symbol-time (and if necessary, spilling over into a second symbol-time as shown in dash). Each resource element of the first region 1204 is labeled by the user device that is permitted to transmit an alignment pulse in that resource element, such as “U1”, “U2”, etc.

Each user device that requires alignment service, can transmit an alignment pulse in its assigned resource element. The base station receives the various alignment pulses in at least two spaced-apart antennas. The base station analyzes signals received by the two antennas coherently, using a common time-base. The base station thereby determines, for each user device, a phase shift or time difference between signals from the two antennas, and thereby determines a dual-antenna angular distribution including a plurality of candidate angles for each user device. The base station can also calculate a single-antenna angular probability distribution using a phased-array antenna, and can compare the single-antenna and dual-antenna distributions to determine an unambiguous arrival angle for the pulse from the user device, and can thereby determine the alignment angle toward the user device relative to a geographical direction such as north.

Analyzing a large number of simultaneous signals, at slightly different frequencies, is within the capabilities of some advanced antenna systems. Other antennas may be challenged by this requirement. Therefore, a second region 1205 is shown as an alternative. The second region 1205 arranges the alignment pulses from a number of user device pulses in a time-spanning configuration, that is, occupying successive symbol-times at a single subcarrier. Each user device is assigned a single symbol-time for transmitting its alignment pulse, which the base station can analyze more easily, one-at-a-time, than the frequency-spanning version 1204. The time-spanning arrangement uses the same number of resource elements as the frequency-spanning arrangement, and is easier for base stations to analyze, but takes more time to complete.

FIG. 13 is a chart showing an exemplary embodiment of waveforms received in two spaced-apart antennas, according to some embodiments. As depicted in this non-limiting example, the phase shift or timing difference of a pulse detected in two spaced-apart antennas is plotted. The pulse is plotted as a wave 1301 as received at the first antenna, “Antenna-1” on the chart. A second wave 1302 shows how the pulse is received at a second “Antenna-2”, which is farther from the source than Antenna-1. Also shown, in dash, is a copy of the Antenna-1 pulse 1301, for visual comparison. The phase shift 1303 between the two waves is a measure of the difference in distances, from the transmitter, of Antennas 1 and 2. Since the separation between the two antennas is known, and the wavelength of the transmission is known, the phase shift 1303 indicates an angle of arrival at the two antennas.

In an alternative determination, the time difference between receptions of the same wave feature at the two antennas, can be determined by suitable electronics. In the chart, the zero-cross time difference 1304 indicates the difference in time, and hence the difference in distances from the transmitter, of the two antennas. The base station can measure either the phase shift 1303 or the time difference 1304, or both, and thereby calculate the angle of arrival. The base station can then calculate the alignment direction toward the source, such as a user device, relative to a geographical direction such as north.

As mentioned, the relative measurement of time or phase in the two antennas requires either that the base station employ the same clock or time-base for analyzing signals from the two antennas, or that the base station know the time offset between the two clocks, so that the base station can calculate the true difference between the reception of the pulse at the two antennas.

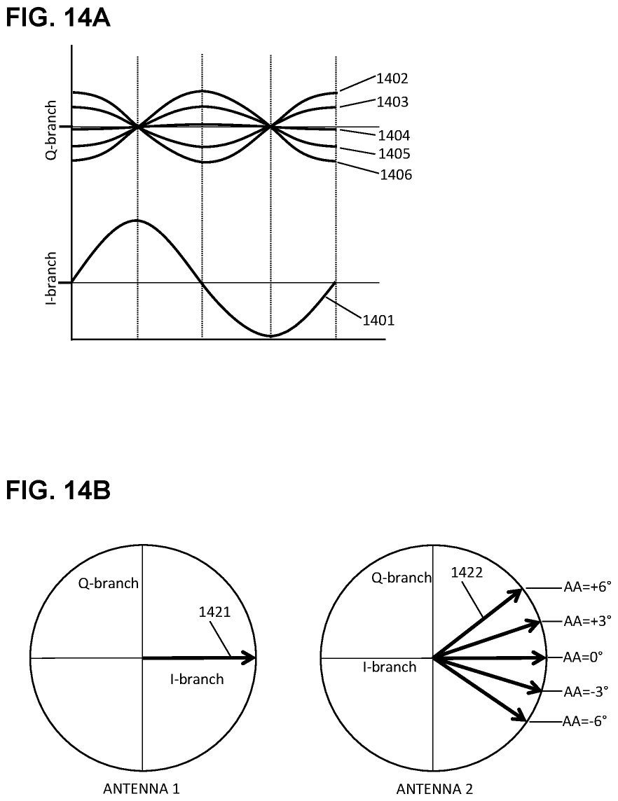

FIG. 14A is a chart showing an exemplary embodiment of waveforms in a quadrature-modulated alignment pulse, according to some embodiments. As depicted in this non-limiting example, waveforms indicate the as-received signals in a first and a second antenna. The first antenna is closer to the source than the second antenna. The received signal in each antenna is separated into an I-branch and an orthogonal Q-branch. For simplicity, the pulse is assumed to have maximum amplitude in the I-branch and zero amplitude in the Q-branch when the wave reaches the first antenna. After propagating to the second antenna, the wave has advanced in phase, and no longer appears exclusively in the I-branch signal of the second antenna, but rather has shifted partially into the Q-branch signal of the second antenna. The amplitude detected in the Q-branch signal of the second antenna thereby provides a measure of the phase shift or time difference associated with the separation between the antennas, and thereby provides a measure of the angle of arrival.

It should be noted that the antenna signals are not generally processed this way, using a common clock or time-base with zero offset between the two separated antennas. Normally, for multi-antenna reception, each antenna includes an empirical clock offset, calibrated using a demodulation reference for example, and therefore the offset depends on the distance from the transmitter. When a clock offset is adjusted separately for the two antennas, that adjustment is configured specifically to eliminate the phase shift or timing difference between the two antennas, for ease of combining the two signals in analysis. However, doing so eliminates the time or phase measurement that is being sought in the present application. To determine the angle of arrival in the present application, the offset between the antenna clocks is set to zero, and hence the phase shift or time difference between the antennas is exposed as shown.

The chart shows the signal received by the first antenna, which in this example is an I-branch waveform 1401 of full amplitude, and zero amplitude in the Q-branch signal. In the second antenna, which is spaced apart from the first antenna, the same signal is received slightly later due to the extra distance, and this causes a phase shift or time difference relative to the signal in the first antenna. The signal in the Q-branch of the second antenna then depends on the angle of arrival, as shown by the various waves in the Q-branch signal of the chart. For example, if the angle of arrival is, say +6 degrees, the phase shift causes amplitude to appear in the Q-branch signal of the second antenna as shown by wave 1402. If the angle is smaller, such as +3 degrees, a lower Q-branch signal is seen such as 1403. If the angle of arrival is zero, the transmission is received simultaneously at the two antennas, in which case the Q-branch signal of the second antenna is the same as the Q-branch signal of the first antenna, which in this example is substantially zero, as depicted in wave 1404. If the angle of arrival is −3 or −6 degrees, the phase shift or time delay is opposite, as shown in waves 1405 and 1406 respectively.

The chart thus shows how a pair of spaced-apart antennas, receiving a pulse from a user device, and analyzing the pulse with quadrature-modulated reception using a common clock, can determine the arrival angle of the pulse. In the depicted example, the clock offset of both antennas is adjusted so that the first antenna sees a full signal in the I-branch and zero in the Q-branch, whereas the second antenna sees the I and Q branches phase-shifted according to the travel time between the antennas.

Depicting the Q-branch as zero in the first antenna is for visualization only; there is no requirement to configure the antennas to maximize one of the branches in one of the antennas. In practice, the signal at the first antenna may have any ratio of I and Q branches. The signal at the second antenna would then have a different ratio, due to the propagation time. Whatever the phase at antenna-1, the base station can calculate the Q/I ratios for the two antennas, determine a difference in the two ratios, and thereby determine the angle of arrival. The base station can then determine the alignment angle by adjusting to the geographic coordinate system.

FIG. 14B is a polar plot showing an exemplary embodiment of a received quadrature-modulated alignment pulse in two spaced-apart antennas, according to some embodiments. As depicted in this non-limiting example, signals arriving at two antennas can be analyzed as quadrature-modulated signals using a common clock or time-base, with no timing offset between the two clocks. A phase shift or timing difference between the two antenna receptions is then related to a difference in travel distance of the signal to the two antennas, and thereby to the angle of arrival. For visualization, we again assume that the arriving signal at Antenna-1 is entirely in the I-branch 1421 and substantially zero amplitude in the Q-branch of Antenna-1, as shown. At Antenna-2, the received signal is phase-shifted due to the extra time required for the electromagnetic wave to reach the second antenna at a different distance, resulting in a positive or negative rotation of amplitude from the I-branch to the Q-branch of the second antenna.

The signal 1422 at Antenna-2, depicted as a vector in this polar plot, thereby indicates, by the amount of amplitude in the Q-branch of Antenna-2, the arrival angle of the transmission. In a particular case, the user device may be located on the perpendicular axis of the antennas, in which case the path length difference is zero and the transmission reaches the two antennas at the same time. The Q-branch amplitude is then the same as for Antenna-1 (in this case zero) thereby indicating the angular position of the user device.

Usually, however, the angle of arrival differs from zero, and the I-branch amplitude rotates into the Q-branch increasingly with the angle of arrival, The figure shows the Q-branch signals for arrival angles of +3, +6, −3, and −6 degrees as indicated. Therefore, if the first antenna sees purely I-branch amplitude, the Q-branch amplitude of the second antenna is directly related to the angle of arrival.

In a more general case, the I-branch and Q-branch are at some arbitrary phase upon reaching the first antenna, depending on what the transmitter produced and how the common clock was set. For arbitrary timing, both I and Q branches are generally non-zero. Then the base station can measure the I and Q branch amplitudes at the two antennas and calculate both antenna Q/I ratios, to reveal the phase shift or timing difference between the antenna signals. For example, the base station can calculate a first ratio equal to the Q amplitude divided by the I amplitude for Antenna-1, and likewise a second ratio for Antenna-2. The phase shift or timing difference of the signal at the two antennas can then be calculated from the difference between the first and second ratios.

The example demonstrates how the angle of arrival can be determined from the differences in I and Q amplitudes in two spaced-apart antennas that share a common clock with zero relative timing offset.

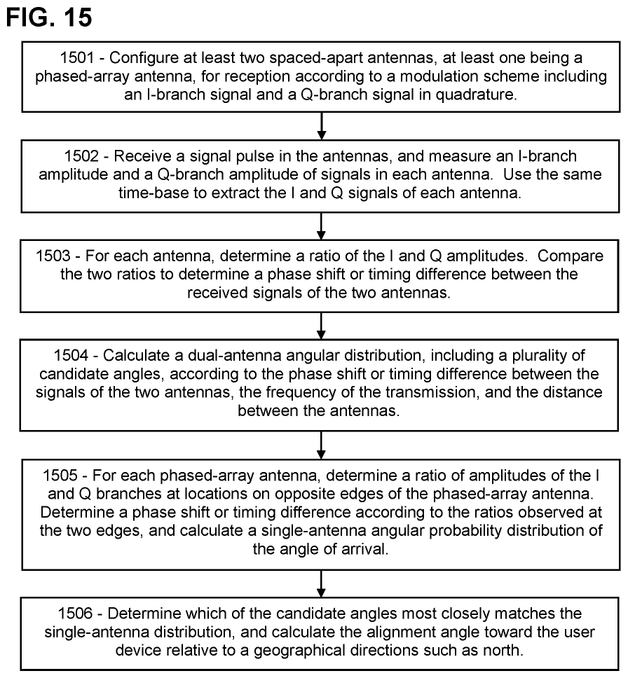

FIG. 15 is a flowchart showing an exemplary embodiment of a procedure for determining an alignment direction according to quadrature-modulated pulses, according to some embodiments. As depicted in this non-limiting example, at 1501 a base station configures two spaced-apart antennas to receive an alignment pulse from a user device, and to analyze the received signals according to quadrature I and Q-branch signals. At 1502, the two antennas receive the pulse at slightly different times due to the separation between the antennas and the angle of arrival of the pulse. The signals from the two antennas are then analyzed according to I and Q amplitudes using the same time-base. At 1503, the base station determines the I and Q amplitudes at the two antennas, and compares the ratios of amplitudes, or a phase representing those ratios, to determine a phase shift or timing difference between the two as-received signals.

At 1504, the base station calculates a dual-antenna angular distribution, including a plurality of candidate angles, according to the phase shift or timing difference observed at the two antennas. At 1505, the base station analyzes signals from various portions of the phased-array antenna and determines a single-antenna angular distribution according to a phase shift or timing difference observed across the phased-array antenna.

At 1506, the base station determines the angle of arrival according to the candidate angle that best matches the single-antenna distribution, and calculates the alignment angle toward the user device by adding or subtracting 180 degrees, and then correcting for the spatial orientation of the antennas, thereby determining the direction toward the user device relative to a geographical standard such as north.

The examples have shown how a base station with multiple spaced-apart antennas can determine the alignment direction toward one user device or a multitude of user devices, quickly and with minimal messaging, by determining a single-antenna angular distribution based on signals from a single phased-array antenna, combined with a dual-antenna angular distribution of candidate angles according to a phase shift or timing difference between signals in the two antennas, and then selecting the candidate angle that most closely matches the single-antenna distribution. The base station can transmit this angle to the user device, for mutual beam alignment. Optionally, the base station can also transmit a series of identical test pulses thereafter, enabling the user device to select an optimal reception beam, if different from the base station's recommended alignment angle. The alignment procedure is quick and uses a minimal amount of resources with a minimal amount of background generation to achieve the desired beam alignment.

The wireless embodiments of this disclosure may be aptly suited for cloud backup protection, according to some embodiments. Furthermore, the cloud backup can be provided cyber-security, such as blockchain, to lock or protect data, thereby preventing malevolent actors from making changes. The cyber-security may thereby avoid changes that, in some applications, could result in hazards including lethal hazards, such as in applications related to traffic safety, electric grid management, law enforcement, or national security.

In some embodiments, non-transitory computer-readable media may include instructions that, when executed by a computing environment, cause a method to be performed, the method according to the principles disclosed herein. In some embodiments, the instructions (such as software or firmware) may be upgradable or updatable, to provide additional capabilities and/or to fix errors and/or to remove security vulnerabilities, among many other reasons for updating software. In some embodiments, the updates may be provided monthly, quarterly, annually, every 2 or 3 or 4 years, or upon other interval, or at the convenience of the owner, for example. In some embodiments, the updates (especially updates providing added capabilities) may be provided on a fee basis. The intent of the updates may be to cause the updated software to perform better than previously, and to thereby provide additional user satisfaction.

The systems and methods may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, or sooner, are loaded into random access memory. Inputs to the application, e.g., from the plurality of users or from any one user, may be by any number of appropriate computer input devices. For example, users may employ vehicular controls, as well as a keyboard, mouse, touchscreen, joystick, trackpad, other pointing device, or any other such computer input device to input data relevant to the calculations. Data may also be input by way of one or more sensors on the robot, an inserted memory chip, hard drive, flash drives, flash memory, optical media, magnetic media, or any other type of file-storing medium. The outputs may be delivered to a user by way of signals transmitted to robot steering and throttle controls, a video graphics card or integrated graphics chipset coupled to a display that maybe seen by a user. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., embedded systems and processors, personal computers, laptop computers, notebook computers, net book computers, handheld computers, personal digital assistants, mobile phones, smart phones, tablet computers, and also on devices specifically designed for these purpose. In one implementation, a user of a smart phone or Wi-Fi-connected device downloads a copy of the application to their device from a server using a wireless Internet connection. An appropriate authentication procedure and secure transaction process may provide for payment to be made to the seller. The application may download over the mobile connection, or over the Wi-Fi or other wireless network connection. The application may then be run by the user. Such a networked system may provide a suitable computing environment for an implementation in which a plurality of users provide separate inputs to the system and method.

It is to be understood that the foregoing description is not a definition of the invention but is a description of one or more preferred exemplary embodiments of the invention. The invention is not limited to the particular embodiments(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater, or different steps than that shown here. All such other embodiments, changes, and modifications are intended to come within the scope of the appended claims.

As used in this specification and claims, the terms “for example”, “e.g.”, “for instance”, “such as”, and “like” and the terms “comprising”, “having”, “including”, and their other verb forms, when used in conjunction with a listing of one or more components or other items, are each to be construed as open-ended, meaning that the listing is not to be considered as excluding other additional components or items. Other terms are to be construed using their broadest reasonable meaning unless they are used in a context that requires a different interpretation.

1. A system comprising a first phased-array antenna, the first phased-array antenna comprising a plurality of reception elements, the system configured to:
a) detect a pulse of electromagnetic energy, arriving at an angle of arrival relative to the first phased-array antenna;
b) determine a first phase or time related to the pulse in a first reception element;
c) determine a second phase or time related to the pulse in a second reception element, the second reception element separated from the first reception element by a width of the first phased-array antenna;
d) determine a first phase shift or timing difference comprising the first phase or time minus the second phase or time; and
e) determine, according to the first phase shift or timing difference, and according to the width of the first phased-array antenna, and according to a frequency of the pulse, a first angular probability distribution of the angle of arrival.

2. The system of claim 1, wherein the pulse is transmitted according to 5G or 6G technology.

3. The system of claim 1, further comprising a second antenna spaced apart from the first phased-array antenna by an antenna-separation distance, wherein the system is further configured to:
a) determine a third phase or time related to the pulse in the second antenna;
b) determine a second phase shift or timing difference comprising at least one of:
i) the third phase or time minus the first phase or time;
ii) the third phase or time minus the second phase or time; or
iii) the third phase or time minus an average of the first and second phases or times.
c) determine, according to the second phase shift or timing difference, and according to the antenna-separation distance, and according to the frequency of the pulse, a plurality of candidate angles;
d) select which of the candidate angles most closely matches the first angular probability distribution; and
e) determine, according to the selected candidate angle, the angle of arrival.

4. The system of claim 3, further configured to:
a) detect a second pulse having a second frequency different from the frequency of the pulse;
b) determine a second angular probability distribution of the angle of arrival according to a phase shift or timing difference between detections of the second pulse in the first and second reception elements;
c) determine a second plurality of candidate angles according to a phase shift or timing difference between detections of the second pulse in the first and second antennas; and
d) perform an algorithm or fit that takes, as input, the first and second angular probability distributions, and the first and second pluralities of candidate angles, and provides, as output, a maximum-likelihood value of the angle of arrival.

5. The system of claim 3, wherein the second antenna comprises a second phased-array antenna, and the system is further configured to:
a) determine a fourth phase or time related to the pulse in a fourth reception element of the second phased-array antenna;
b) determine a fifth phase or time related to the pulse in a fifth reception element of the second phased-array antenna, the fourth reception element separated from the fifth reception element by a width of the second phased-array antenna;
c) determine a fifth phase shift or timing difference comprising the fifth phase or time minus the fourth phase or time;
d) determine, according to the fifth phase shift or timing difference, and according to the width of the second phased-array antenna, and according to the frequency of the pulse, a fifth angular probability distribution of the angle of arrival; and
e) calculate an average of the first and fifth angular probability distributions.

6. The system of claim 3, further configured to:
a) determine, according to the angle of arrival and an orientation of the first phased-array antenna, an alignment angle toward a wireless entity related to the pulse, the alignment angle being relative to a geographical coordinate system;
b) transmit a message to the wireless entity indicating the alignment angle or 180 degrees plus the alignment angle.

7. The system of claim 6, further configured to transmit, according to the alignment angle, a plurality of identical pulsed transmissions after transmitting the message.

8. The system of claim 1, further comprising a sixth antenna and a seventh antenna, wherein the sixth and seventh antennas are spaced apart by an antenna separation distance, and the system is further configured to:
a) determine a sixth phase or time related to the pulse in the sixth antenna;
b) determine a seventh phase or time related to the pulse in the seventh antenna;
c) determine a seventh phase shift or timing difference comprising the sixth phase or time minus the seventh phase or time;
d) determine, according to the seventh phase shift or timing difference, and according to the antenna separation distance, and according to the frequency of the pulse, a seventh plurality of candidate angles;
e) selecting which candidate angle of the seventh plurality of candidate angles most closely matches the first angular probability distribution; and
f) determining, according to the selected candidate angle, the angle of arrival.

9. The system of claim 8, wherein the first phased-array antenna is positioned between the sixth and seventh antennas, and the system is further configured to:
a) determine an eighth phase shift or timing difference comprising the sixth phase or time minus the first or second phase or time;
b) determine, according to the eighth phase shift or timing difference, an eighth plurality of candidate angles;
c) determine which particular candidate angle of the eighth plurality of candidate angles most closely matches the seventh plurality of candidate angles and the first angular probability distribution; and
d) determine, according to the particular candidate angle, the angle of arrival.

10. The system of claim 1, wherein:
a) the system further comprises a first plurality of phased-array antennas, wherein the phased-array antennas of the first plurality are spaced apart from each other and are oriented in different directions;
b) the system further comprises a second plurality of non-directional antennas, wherein the non-directional antennas of the second plurality are spaced apart from each other;
c) and wherein the system is further configured to:
d) determine, for each particular phased-array antenna of the first plurality, an angular probability distribution related to an angle of arrival of the pulse relative to the orientation of the particular phased-array antenna;
e) determine, for each pair of non-directional antennas of the second plurality, one or more candidate angles related to an angle of arrival of the pulse relative to a separation between the antennas of the pair; and
f) determine an alignment direction toward a transmitter of the pulse, according to a fit or formula that takes as input the angular probability distributions and the candidate angles, and provides as output the alignment direction toward the transmitter of the pulse.

11. The system of claim 1, further configured to:
a) assign, to each user device of a plurality of user devices, a different resource element of a resource grid, each resource element defined by a subcarrier and a symbol-time, respectively;
b) receive a plurality of user device pulses in the assigned resource elements;
c) and for each user device pulse:
i) determine an angular probability distribution related to a phase shift or timing difference between the first and second reception elements;
ii) determine a plurality of candidate angles according to a phase shift or timing difference between receptions at the phased-array antenna and a second antenna spaced apart from the phased-array antenna;
iii) select which candidate angle most closely matches the angular probability distribution; and
iv) calculate, according to the selected candidate angle, an alignment direction toward the user device.

12. The system of claim 1, further configured to:
a) receive a first signal from the first reception element;
b) separate the first signal into a first I-branch signal and a first Q-branch signal, the first Q-branch signal orthogonal to the first I-branch signal;
c) measure a first I-branch amplitude of the first I-branch signal and a first Q-branch amplitude of the first Q-branch signal, and calculate a first ratio of the first Q-branch amplitude divided by the first I-branch amplitude;
d) receive a second signal from the second reception element;
e) separate the second signal into a second I-branch signal and a second Q-branch signal, the second Q-branch signal orthogonal to the second I-branch signal;
f) measure a second I-branch amplitude of the second I-branch signal and a second Q-branch amplitude of the second Q-branch signal, and calculate a second ratio of the second Q-branch amplitude divided by the second I-branch amplitude; and
g) determine the first phase shift or timing difference according to a difference between the first ratio and the second ratio.

13. A method for a user device to determine an alignment angle toward a base station, the method comprising:
a) receiving, from the base station, an indication of an assigned subcarrier and an assigned symbol-time;
b) at the assigned symbol-time, transmitting an alignment pulse comprising electromagnetic energy at a frequency corresponding to the assigned subcarrier;
c) then receiving, from the base station, a message indicating a suggested alignment direction;
d) then receiving a plurality of test pulses, wherein:
i) each test pulse is transmitted, by the base station, with the same amplitude, direction, modulation, and frequency;
ii) each test pulse is received, by the user device, using a different reception beam direction;
e) then determining a user device alignment angle toward the base station according to which reception beam direction provided a best reception of one of the test pulses.

14. The method of claim 13, wherein the alignment pulse occupies a single resource element of a resource grid, and each test pulse occupies another single resource element of the resource grid.

15. The method of claim 13, further comprising:
a) prior to receiving the indication of the assigned subcarrier and symbol-time, transmitting an alignment request message indicating that the user device requests assistance in determining an alignment angle.

16. The method of claim 13, further comprising:
a) prior to receiving the indication of the assigned subcarrier and symbol-time, transmitting an entry request message on a contention-based channel, wherein the entry request message indicates that the user device requests registration in a cell of the base station; and
b) wherein the message indicating the suggested alignment direction is appended to or multiplexed with at least one of:
i) an RAR (random access response) message;
ii) a Msg4 (fourth message of a four-stage initial access procedure) message; or
iii) a MsgB (second message of a two-stage initial access procedure).

17. Non-transitory computer-readable media in a base station of a wireless network, the media containing instructions that, when implemented in a computing environment, cause a method to be performed, the method comprising:
a) configuring two antennas, at least one being a phased-array antenna, to receive signals according to the same clock or time-base;
b) receiving, in the two antennas, a pulse transmitted by a user device;
c) determining a phase shift or timing difference between pulse signals received in two spaced-apart reception elements of the phased-array antenna;
d) determining, according to the phase shift or timing difference, and according to a separation between the two spaced-apart reception elements, an angular probability distribution of an angle of arrival of the pulse;
e) determining a second phase shift or timing difference between pulse signals received in the two antennas;
f) determining, according to the second phase shift or timing difference, and according to a separation between the antennas, a plurality of candidate angles;
g) selecting which candidate angle most closely matches the angular probability distribution; and
h) determining, according to the selected candidate angle, the angle of arrival.

18. The media of claim 17, the method further comprising:
a) determining, according to the angle of arrival and an orientation of the two antennas, an alignment direction toward the user device relative to a geographical coordinate system; and
b) transmitting an alignment message to the user device, on a beam aimed according to the alignment angle, a message indicating the alignment angle plus 180 degrees.

19. The media of claim 18, the method further comprising;
a) transmitting, after the alignment message, a plurality of test pulses, each test pulse having the same frequency, amplitude, modulation, and direction.

20. The media of claim 18, wherein:
a) the pulse occupies a single resource element of a resource grid, at a predetermined symbol-time and a predetermined subcarrier; and
b) each test pulse occupies successive resource elements comprising or concatenated with the alignment message.
